(19) United States
(12) Patent Application Publication
(10) Pub. No.: US 2022/0174566 A1
(43) Pub. Date: Jun. 2, 2022

(54) DEFINING AUTOMATIC NEIGHBOR RELATION MEASUREMENTS FOR LOW POWER DEVICES

(71) Applicant: Telefonaktiebolaget LM Ericsson (PUBL), Stockholm (SE)

(72) Inventors: Ritesh Shreevastav, UPPLANDS VÄSBY (SE); Antti Ratilainen, ESPOO (FI); Santhan Thangarasa, VÄLLINGBY (SE); Muhammad Kazmi, SUNDBYBERG (SE)

(21) Appl. No.: 17/593,820

(22) PCT Filed: Mar. 25, 2020
(86) PCT No.: PCT/EP2020/058325

§ 371 Date: Sep. 24, 2021

Related U.S. Application Data
(60) Provisional application No. 62/825,066, filed on Mar. 28, 2019.

(51) Int. Cl. H04W 36/08; H04W 36/30

(52) U.S. Cl. CPC H04W 36/08; H04W 36/30

(57) ABSTRACT

A method performed by a user equipment (UE) served in a first cell includes determining within a time period that at least one criteria is met for triggering acquiring a Cell Global Identity (CGI) in a second cell. The UE determines within the time period that at least one second criteria is met for triggering a cell change from a source cell to a target cell. The wireless device obtains information comprising a prioritization of one of the acquiring the CGI and the cell change over the other one of acquiring the CGI and the cell change. Based on the information comprising the prioritization, the wireless device performs one of acquiring the CGI in the second cell or the cell change from the source cell to the target cell.

### TECHNICAL FIELD

The present disclosure relates, in general, to wireless communications and, more particularly, systems and methods for defining Automatic Neighbor Relation (ANR) measurements for low power devices.

### BACKGROUND

In Long Term Evolution (LTE) and wideband code division multiple access (WCDMA), the purpose of Automatic Neighbor Relation (ANR) is to identify new neighbour cells (nCells). Once the nCells are identified the knowledge can be used, for example, to enable handovers, for planning and optimization of Physical Cell Identities (PCI), and/or for Random Access Channel (RACH) configuration and interference co-ordination. Handovers are not supported in Narrowband-Internet of Things (NB-IoT). Nonetheless, this feature can be advantageous from a NB-IoT perspective as specified above for Radio Access Network (RAN) internal auto-configuration and optimization and also as input to a cell planner and for optimizing and troubleshooting various eNodeB (eNB) parameters.

Examples of parameters that can be auto-configured or optimized may relate to: eNB transmission (power, antenna location and tilt); Idle mode mobility (signal quality and strength thresholds); Narrowband frequency signal (NRS) frequency reuse (physical cell identifier based) narrowband-physical broadcast channel (NPBCH), physical downlink shared channel (PDSCH) scheduling information block (SIB1), narrowband primary synchronization signal (NPSS), narrowband secondary synchronization signal (NSSS) intercell interference; Narrowband physical random access channel (NPRACH) detection and false alarm.

In LTE, ANR procedure can be viewed as two step procedure. The first step may include receiving unknown PCI in measurement report from UE. The step may include requesting the UE to read and report cell global identity (CGI), tracking area code (TAC), Public Land Mobile Networks (PLMNs) for specified PCI (PCI+SIB1).

In RAN2 #104, it has been agreed to have an immediate single set of measurements for ANR. The solution direction based on option a (Immediate, single set of measurements) includes:
Single set of measurements only.
No new measurement requirements.
ANR measurement reporting using the user equipment (UE) Information Request/Response framework is supported. Other methods are for further study.
ANR reporting for the cyclic prefix (CP) solution is not supported in Rel-16.

### Cell Re-Selection

In the Radio Resource Control idle (RRC idle) state, the UE performs measurements such as, for example, reference signal received power (RSRP), reference signal received quality (RSRQ), reference signal-signal-to-noise ratio (RS-SINR) for cell selection and reselection purposes. When camped on a cell, the UE regularly searches for a better cell according to the cell reselection criteria. If a better cell is found, that cell is selected. The change of cell may imply a change to a new cell within the same radio access technology (RAT) or to a cell of a different RAT. That is the UE performs intra-frequency, inter-frequency or inter-RAT cell reselection.

The cell reselection is performed by the UE autonomously based on the network configured parameters such as, for example, Absolute Radio Frequency Channel Number (ARFCN) of carriers, signal quality/strength offsets, cell reselection timer, etc.

For example, in case of intra-frequency cell reselection in Long Term Evolution (LTE), the UE identifies new intra-frequency cells and perform RSRP and RSRQ measurements of identified intra-frequency cells without an explicit intra-frequency neighbour list containing physical layer cell identities. The UE is able to evaluate whether a newly detectable intra-frequency cell meets the reselection criteria within a pre-defined time period. This time is defined as a function of Discontinuous Reception (DRX) cycle used in idle state.

### Acquisition of System Information

The UEs are required to detect System Information (SI) of neighboring cells in Evolved-Universal Terrestrial Radio Access (EUTRA). There are mainly two types of SI that are needed to identify the Cell Global Identifier (CGI) of the new cell given that the new cell has already been detected, which means that the PCI of the cell already is known. The two types of SIs which are needed to identify the CGI are master information block (MIB) and system information block (SIB1). MIB is transmitted on the physical broadcast channel (PBCH) while SIB1 is multiplexed into physical downlink shared channel (PDSCH). MIB is transmitted in subframe #0 with a periodicity of 40 ms and 4 redundancy versions are transmitted within this period. SIB1 is transmitted on subframe #5 and it has a periodicity of 80 ms. The method of detecting the CGI is the same for both frequency division duplex (FDD), half duplex-FDD (HD-FDD), and time division duplex (TDD). The reading of SI for the acquisition of CGI is carried out during measurement gaps which are autonomously created by the UE.

In LTE, the MIB includes a limited number of most essential and most frequently transmitted parameters that are needed to acquire other information from the cell, and is transmitted on broadcast channel (BCH). In particular, the following information is currently included in MIB:
Downlink (DL) bandwidth,
Physical Hybrid-ARQ Indicator Channel (PHICH) configuration, and
System frame number (SFN).

The MIB is transmitted periodically with a periodicity of 40 ms and repetitions made within 40 ms. The first transmission of the MIB is scheduled in subframe #0 of radio frames for which the SFN mod 4=0, and repetitions are scheduled in subframe #0 of all other radio frames.

In LTE, the SIB1 contains, for example, the following information:
Public Land Mobile Network (PLMN) identity,
Cell identity,
Closed Subscriber Group (CSG) identity and indication,
Frequency band indicator,
SI-window length,
Scheduling info for other SIBs.

The LTE, SIB1 may also indicate whether a change has occurred in the SI messages. The UE is notified about coming change in the SI by a paging message, from which it will know that the system information will change at the next modification period boundary. The modification period boundaries are defined by SFN values for which SFN mod m=0, where m is the number of radio frames comprising the modification period. The modification period is configured by system information.

The LTE, SIB1, as well as other SIB messages, is transmitted on Downlink-Shared Channel (DL-SCH). The SIB1 is transmitted with a periodicity of 80 ms and repetitions made within 80 ms. The first transmission of SystemInformationBlockType1 is scheduled in subframe #5 of radio frames for which the SFN mod 8=0, and repetitions are scheduled in subframe #5 of all other radio frames for which SFN mod 2=0.

In case of inter-RAT Universal Terrestrial Radio Access Network (UTRAN), the UE reads the MIB and SIB3 of the target cell UTRAN cell to acquire its CGI.

FIG. 1 illustrates Evolved-Universal Terrestrial Access (E-UTRA) Frequency Division Duplexing (FDD) MIB and SIB1 acquisition. It is assumed in 3^{rd} Generation Partnership Project (3GPP) TS 36.133 that the UE needs to do Automatic Gain Control (AGC) on target carrier before reading MIB and also before SIB1, and that five subframes may have to be blanked for that operation. Moreover, it is assumed that three blocks from MIB and three redundancy versions from SIB1, from the same 40 and 80 ms period, respectively, are needed. Due to unknown start of the MIB acquisition, it is accounted for that for each of MIB and SIB1 acquisition, five gaps are allowed each with duration of four subframes.

Certain problems exist. For example, ANR measurements and reporting are not supported by NB-IoT. Thus, it has not been specified how such are performed. Currently, it has been agreed in 3GPP that the NB-IoT user equipment (NB-IoT UE) performs idle mode measurements for ANR, but no further details have been discussed. Performing the measurements and/or reporting as in legacy LTE may cause unnecessary power consumption in the UE, which is especially important in the case of NB-IoT UEs with long-intended battery life. Also, the existing idle mode measurements may cause issues and/or interfere with Extended Discontinuous Reception (eDRX)/Power Saving Mode (PSM) mechanisms, which may have negative impact on the UE battery consumption.

As part of ANR, a UE is supposed to identify the CGI of the strong cell. Performing CGI measurements requires the UE to read the master information block (MIB) and secondary information block (SIB) of the other cell (detected strong cell) which can be power consuming.

UE has to perform measurement immediately after going from connected mode to idle mode. It is essential that power efficient measurements are defined whilst the measurements are also reliable.

An NB-IoT device performs positioning measurements in low activity RRC state such as, for example, RRC Idle mode, RRC inactive state, etc, to save the device power. The location server, which may include an Evolved-Serving Mobile Location Center (E-SMLC), may request/ping the UE to perform positioning measurements. The request may also comprise an assistance data or positioning measurement configuration. The location server provides the needed configuration in RRC connected state. After the UE is released to idle mode, the UE may perform the positioning measurements and report the results of the measurements to the location server. Examples of positioning measurements are Reference Signal Time Difference (RSTD), Enhanced-Cell Identifier (E-CID) measurements, etc. Examples of E-CID measurements are UE Reception-Transmission (Rx-Tx) time difference, NRSRP, NRSRQ, etc.

The RSTD positioning measurement is used for Observed Time Difference Of Arrival (OTDOA) positioning method. RSTD is the received time difference of reference signals from a pair of cells: a reference cell and a neighbor cell. RSTD is performed by the UE using at least Narrowband Positioning Reference Signals (NPRS). The UE is configured with OTDOA assistance information containing NPRS related information such as, for example, NPRS occasion length, NPRS occasion periodicity, etc. The UE can further be configured with dense NPRS (e.g. densePrsConfig). The dense NPRS indicates that the UE (e.g. target device) supports a subset of the additional NPRS configurations which comprises a NPRS positioning occasion length (Nprs) with any of these values: 10 subframes, 20 subframes, 40 subframes, 80 subframes and 160 subframes (in addition to the legacy Positioning Reference Signal (PRS) occasion length of: 1, 2, 4 and 6 subframes). Nprs is the number of downlink (DL) subframes in a NPRS positioning occasion. The NPRS positioning occasion is transmitted with certain NPRS periodicity (Tnprs) e.g. 160 ms, 320 ms, 640 ms, 1280 ms.

### SUMMARY

Certain aspects of the present disclosure and their embodiments may provide solutions to these or other challenges. For example, according to certain embodiments, methods, systems, and techniques are provided for defining Automatic Neighbor Relation (ANR) measurements for low power devices.

According to certain embodiments, a method performed by a user equipment (UE) served in a first cell includes determining within a time period that at least one criteria is met for triggering acquiring a Cell Global Identity (CGI) in a second cell and determining within the time period that at least one second criteria is met for triggering a cell change from a source cell to a target cell. The UE obtains information including a prioritization of one of acquiring the CGI and the cell change over the other one of the acquiring the CGI and the cell change. Based on the information including the prioritization, the UE performs one of the acquiring the CGI in the second cell or the cell change from the source cell to the target cell.

According to certain embodiments, a UE served in a first cell includes processing circuitry configured to determine within a time period that at least one criteria is met for triggering acquiring a CGI in a second cell and determine within the time period that at least one second criteria is met for triggering a cell change from a source cell to a target cell. The processing circuitry is configured to obtain information including a prioritization of one of acquiring the CGI and the cell change over the other one of the acquiring the CGI and the cell change. Based on the information including the prioritization, the processing circuitry is configured to perform one of the acquiring the CGI in the second cell or the cell change from the source cell to the target cell.

According to certain embodiments, a method performed by a network node includes transmitting, to a UE, information comprising a prioritization of one of acquiring a CGI and a cell change over the other one of the acquiring the CGI and the cell change.

According to certain embodiments, a network node includes processing circuitry configured to transmit, to a UE, information including a prioritization of one of acquiring a CGI and a cell change over the other one of the acquiring the CGI and the cell change.

Certain embodiments may provide one or more of the following technical advantages. For example, one technical advantage may be that certain embodiments ensure that a user equipment (UE) in idle mode does not interfere with Extended Discontinuous Reception (eDRX)/Power Saving Mode (PSM) mechanisms while performing the required measurements for ANR. Thus, eDRX/PSM works as intended, allowing longer battery life.

As another example, a technical advantage may that certain embodiments help save UE battery while at the same time enabling UE to perform the ANR measurements.

As still another example, a technical advantage may be that certain embodiments well specify UE behavior in case the UE is performing the cell reselection while also performing the ANR measurement (e.g. acquiring the Cell Global Identity (CGI) etc.) on a cell.

As yet another example, a technical advantage may be that certain embodiments ensure that the cell reselection performance is not degraded due to ANR measurements in idle state.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates E-UTRA FDD MIB and SIB1 acquisition;

FIG. 2 illustrates a user equipment (UE) performing CGI detection at the 4^{th} Cell Reselection, according to certain embodiments;

FIG. 3 illustrates a scenario where a target ANR cell and a target cell for a cell change (e.g., re-selection) are not the same, according to certain embodiments;

FIG. 4 illustrates an example wireless network, according to certain embodiments;

FIG. 5 illustrates an example network node, according to certain embodiments;

FIG. 6 illustrates an example wireless device, according to certain embodiments;

FIG. 7 illustrate an example user equipment, according to certain embodiments;

FIG. 8 illustrates a virtualization environment in which functions implemented by some embodiments may be virtualized, according to certain embodiments;

FIG. 9 illustrates a telecommunication network connected via an intermediate network to a host computer, according to certain embodiments;

FIG. 10 illustrates a generalized block diagram of a host computer communicating via a base station with a user equipment over a partially wireless connection, according to certain embodiments;

FIG. 11 illustrates a method implemented in a communication system, according to one embodiment;

FIG. 12 illustrates another method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates an example method by a wireless device for Automatic Neighbor Relation (ANR) measurements for low power devices, according to certain embodiments;

FIG. 16 illustrates an exemplary virtual computing device for ANR measurements for low power devices, according to certain embodiments;

FIG. 17 illustrates another example method by a wireless device for ANR measurements for low power devices, according to certain embodiments;

FIG. 18 illustrates another exemplary virtual computing device for ANR measurements for low power devices, according to certain embodiments;

FIG. 19 illustrates an example method by a network node for ANR measurements for low power devices, according to certain embodiments;

FIG. 20 illustrates another exemplary virtual computing device for ANR measurements for low power devices, according to certain embodiments;

FIG. 21 illustrates another example method by a network node for ANR measurements for low power devices, according to certain embodiments;

FIG. 22 illustrates another exemplary virtual computing device for ANR measurements for low power devices, according to certain embodiments;

FIG. 23 illustrates an example method by a wireless device, according to certain embodiments;

FIG. 24 illustrates another exemplary virtual computing device, according to certain embodiments;

FIG. 25 illustrates another example method by a network node, according to certain embodiments; and

FIG. 26 illustrates another exemplary virtual computing device, according to certain embodiments.

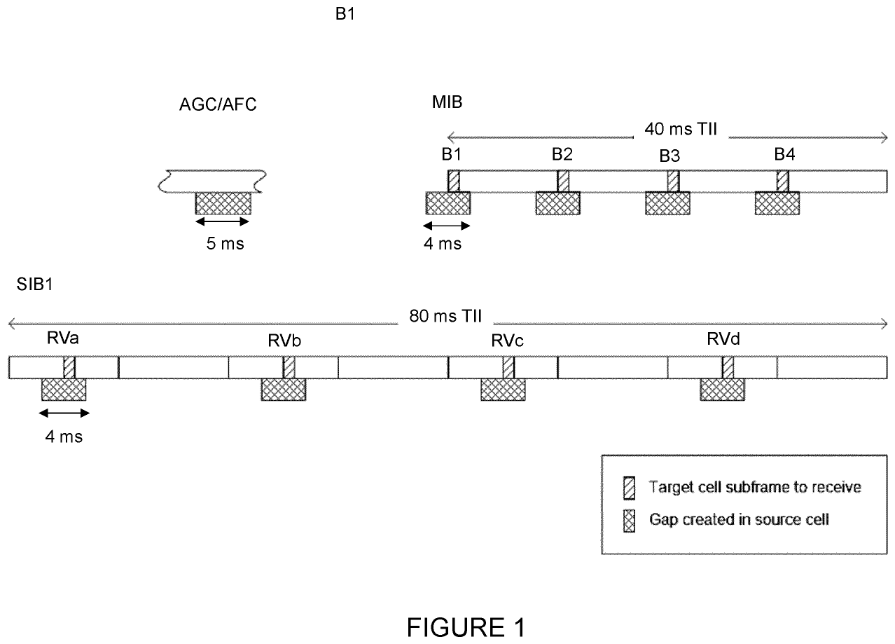

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a user equipment (UE) (directly or via another node) and/or with another network node. Examples of network nodes are NodeB, Master eNodeB (MeNB), ENB, a network node belonging to a Master Cell Group (MCG) or Secondary/Slave Cell Group (SCG), base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g., Mobile Switching Center (MSC), Mobile Management Entity (MME), etc.), Operations and Management (O&M), Operations Support System (OSS), Self Optimized Network (SON), positioning node (e.g., Evolved-Serving Mobile Location Center (E-SMLC)), Minimization of Drive Test (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Data Assistant (PDA), Tablet, mobile terminals, smart phone, laptop embedded equipped (LEE), laptop mounted equipment (LME), Universal Serial Bus (USB) dongles, UE category M1, UE category M2, Proximity Services UE (ProSe UE), Vehicle-to-Vehicle UE (V2V UE), Vehicle-to-Anything UE (V2X UE), etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB) or UE.

The embodiments described in the disclosure are applicable in any UE Radio Resource Control (RRC) state, especially in a UE RRC state in which the UE autonomously perform a cell change. In the cell change procedure, the UE changes or switches from a source cell (previous or old serving cell) to a target cell (new source or serving cell). Examples of RRC states are: RRC connected state, RRC idle state, etc. Examples of low activity RRC states are: RRC idle state, RRC inactive state, etc. Examples of cell change procedures are: cell reselection, handover, RRC connection release with redirection, RRC re-establishment, etc.

In LTE, ANR is performed during connected mode. As such, the UE detects the Physical Cell Identity (PCI) of a strong cell and reports it via a Measurement Report. Thereafter, the network can configure an autonomous gap for the UE. The UE uses the gap to identify the Cell Global Identity (CGI) of the cell (reading Master Information Block (MIB) and System Information Block-1 (SIB1).

More specifically, identifying the CGI implies that the UE needs to read the MIB and System Information Block (SIB) information of the detected strong cell. This may be battery consuming. Thus, according to certain embodiments, the network may ensure that UE is not bound to perform the CGI reporting frequently.

As used herein, a cell may be considered a strong cell if, for example, the measured reference signal received power (RSRP) or reference signal received quality (RSRQ) values from that cell exceed a certain threshold value. For example, in a particular embodiment, the threshold may be the RSRP/RSRQ threshold parameters used for cell reselection. The threshold may be an absolute value, in a particular embodiment. In another embodiment, the threshold may be a difference between the serving/camped cell and the strong cell.

According to certain embodiments, in order to save battery in Narrowband-Internet of Things (NB-IoT), it is recommended that the UE performs logged measurements during idle mode. As such, there may not be any interaction with the network for CGI discovery. The UE may autonomously decide to obtain that or based upon white or black list of PCI that is configured by the Network.

A white list contains PCI values that the network is interested in and requests the UE to perform ANR measurements upon. By contrast, a black list contains PCI values that the network is not interested in, and thus, a black list informs the UE that on these PCIs the UE should not perform ANR measurements.

At times, the detected strong cell PCI may not be in the white or black list. Or, the list may be unavailable. In such cases, and also even when the UE detected strong cell based upon the list, it may be specified as to when the UE should try to discover the CGI of the cell, according to certain embodiments. There should be balance between UE power saving and still be able to perform ANR measurements.

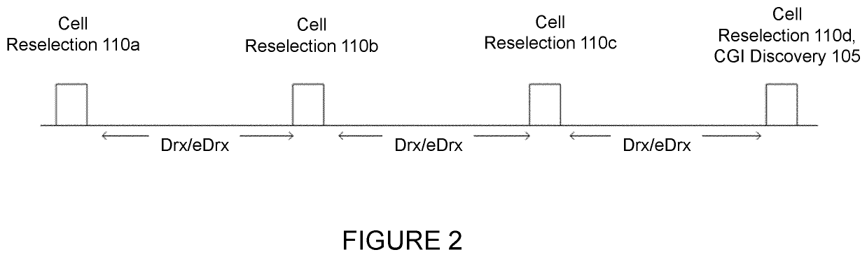

Some example embodiments are provided below to show when the UE may perform the CGI discovery. For example, FIG. 2 illustrates a UE performing CGI detection 105 at the 4^{th} Cell Reselection 110d after three Cell Reselections 110a-c.

According to certain embodiments, if the UE happens to detect the same strong cell as a cell reselection candidate for a certain count/periodicity, the UE may perform the identification of the CGI and store/log the value. This may be especially useful when the UE is not able to perform the cell reselection to the strong cell such as, for example, when the strong cell is private, an inter-RAT cell, or a barred cell. In these scenarios, the UE may not be able to perform cell reselection. As such, according to certain embodiments, it may be specified as to how long after detecting a strong cell the UE should perform the CGI discovery. These techniques may also be helpful for stationary UEs, which may perform the measurements occasionally and not necessarily perform any mobility related activity such as cell reselection.

An NB-IoT device may be configured with a long Enhanced-Discontinuous Reception (E-DRX) cycle such that the UE may be in sleep mode for approximately three hours. According to certain embodiments, however, once the UE has been selected to perform ANR measurements, the UE may skip the long E-DRX cycle and switch to normal DRX cycle and perform measurements in idle mode using the intervals defined by normal DRX cycle for intra/inter frequency measurement (cell reselection measurement). In a particular embodiment, the network may specify for how long the UE is required to perform the measurement to identify the strong cell and when the UE is required to perform the CGI discovery. Additionally or alternatively, the network may setup a response time during which the UE is required to report back to the network with the result. In a particular embodiment, the result could as well be: no PCI detected that was of interest to the network. Thus, the result may be an empty CGI result. After sending the result to the network, the UE may switch back to the long DRX cycle, in a particular embodiment.

An exemplary configuration for the idle mode measurement for ANR that could be specified by RRC unicast or broadcast signalling may include Table 1 as below in 3GPP TR 36.133 V15.5.0:

TABLE 1

| DRX cycle length [s] | [number of DRX cycles] |
|---|---|
| 0.32 | 4 |
| 0.64 | 4 |
| 1.28 | 2 |
| 2.56 | 2 |

Thus, for each respective DRX cycle length, a UE may be expected to perform ANR measurements after certain DRX cycle.

If the UE happens to perform the cell reselection to the detected strong cell, the UE may record the CGI. In this case, as the cell would be serving cell, no extra battery is consumed to identify the CGI.

According to a particular embodiment, for the strong cell detection, a threshold value may be defined that is an offset to the cell reselection parameters. According to a particular embodiment, a duration may also be specified as to how long or how often the cell should remain a strong cell before confirming it as a strong cell.

An example offset description is provided in 3GPP TS 36.304 V15.2.0:
Intra-frequency and equal priority inter-frequency Cell Reselection criteria

The cell-ranking criterion Rₛ for serving cell and Rₙ for neighbouring cells is defined by:

$${R}_{s} = {Q}_{meas} {,}_{s} + {Q}_{Hyst} - {Qoffset}_{temp} + {Qoffset}_{SCPTM}$$

$${R}_{n} = {Q}_{meas} {,}_{n} - Qoffset - {Qoffset}_{temp} + {Qoffset}_{SCPTM}$$

where as in Table 2:

TABLE 2

| | |
|---|---|
| Qₘₑₐₛ | RSRP measurement quantity used in cell reselections. |
| Qoffset | For intra-frequency: Equals to Qoffset_{s, n}, if Qoffset_{s, n} is valid, otherwise |
| | this equals to zero. |
| | For inter-frequency: |
| | Except for NB-IoT, equals to Qoffset_{s, n} plus Qoffset_{frequency}, if Qoffset_{s, n} is |
| | valid, otherwise this equals to Qoffset_{frequency}. |
| | For NB-IoT equals to QoffsetDedicated_{frequency} for any frequency other than |
| | the frequency of the dedicated frequency offset, if QoffsetDedicated_{frequency} |
| | is valid, otherwise this equals to Qoffset_{frequency} (if QoffsetDedicated_{frequency} |
| | is valid Qoffset_{frequency} is not used). |
| Qoffsetₜₑₘₚ | Offset temporarily applied to a cell as specified in [3] |
| Qoffset_{SCPTM} | Offset temporarily applied to an SC-PTM frequency as specified below. |
| | The offset is applied to all cells on the SC-PTM frequency. If Qoffset_{SCPTM} |
| | is valid, Qoffset for inter-frequency neighbour cells is not used. |
| StrongCellParameter | Threshold for detecting strong cell |
| durationForStrong | Time duration as how long the cell would be required to be considered as |
| CellDetection | strong cell. This could be based upon several cell reselection durations. If |
| | UE finds a cell to have signal > StrongCellParameter for n consecutive cell |
| | reselection count, UE can assume that the cell is strong cell. Upon which |
| | the UE shall read the CGI of the cell. |
| | If UEs serving cell fulfils that criteria, then UE will log it after this |
| | duration. |

Rn is ranking for neighbor cell. For a strong cell detection, the comparison could be done such that the Rn/Rs>X; where X is configurable, according to certain embodiments.

A strong signal parameter could also be configured such that, if Rn>StrongCelllparameter, strong cell detection criteria is met, according to certain embodiments.

Certain other embodiments in the UE are related to UE behavior with regard to cell change and ANR measurement which can take place in parallel. For example, there may be scenarios where the cell change (e.g. cell re-selection to a target cell) criteria and ANR measurement (e.g. CGI, Evolved CGI (ECGI)) criteria are triggered at the same time or during at least a partially overlapping time period. For instance, while the UE is performing ANR measurement, a criteria to perform the cell change (e.g., cell reselection to a target cell) may also be triggered. This is an example of partially overlapping time over which both cell change and ANR measurements are triggered or performed by the UE.

In another example, while the UE is performing cell change, criteria to perform the ANR measurement may also be triggered. This is also an example of partially overlapping time over which both cell change and ANR measurements are triggered or performed by the UE. In yet another example, the criteria to perform the cell change as well as the criteria to perform the ANR measurement are triggered at the same time. This is an example where both cell change procedure and ANR measurements are triggered or started by the UE at the same time. However, it may not always be possible for the UE to carry out both procedures in parallel or even during partially overlapping time. The UE behavior in this case is not known. According to certain embodiments disclosed herein, however, methods are presented that can be applied in the UE for adapting its UE behavior when both conditions for triggering cell re-selection and ANR are met. They can be divided into two scenarios, as explained in more detail below.

### Scenario A: Cell Re-Selection Cell is Same as ANR Cell:

In scenario A, it is assumed that UE is currently served by a first cell (cell1) and it has found a new cell (cell2) which has fulfilled the criteria for ANR measurement on cell2. The criteria to initiate or trigger or start a procedure to perform ANR measurement may be based on comparison of the PCI of cell2 with obtained information. Examples of obtained information are pre-defined information, history, or statistics or information received from the network node such as, for example, from a serving BS of cell1. Examples of received information may include: a list of one or more cells which should not be measured for ANR measurements (e.g., a black list), a list of one or more cells which should be measured for ANR measurements (e.g., a white list), etc. Examples of criteria for triggering or initiating the procedure to perform ANR measurements may include: the PCI of that cell (e.g. cell2) is part of the white list that the network node is interested in, the PCI of that cell (e.g. cell2) does not belong to the black list that the network node is not interested in, etc. It is further assumed that, the cell change criteria (e.g. cell re-selection criteria) may also be fulfilled when the UE has found cell2 as a target cell for cell re-selection. In scenario A, it is assumed that the same target cell (cell2) is the candidate for cell change as well as the candidate for doing the ANR measurement. In this case, the UE behavior can be signaled from the serving network node. Alternatively, it may be a pre-defined rule telling the priority order according to which the UE should perform different tasks such as, for example, ANR measurements, cell change (e.g. cell reselection), etc. The procedures for ANR measurement and cell change may be triggered at the same time or during a partially overlapping time period as described earlier.

According to certain embodiments, in this scenario, the serving network node may signal to the UE the priority of action. One example of signaled information may include information indicating whether UE should carry out the cell change (e.g. cell re-selection) or not and/or whether the UE should skip the ANR measurement. The motivation for skipping the ANR measurement of cell2 may be that the UE is required to receive the MIB and SIBs of the cell2 as part of the cell re-selection procedure. Thus, the ECGI of that cell is going to be known to the UE even without performing the ANR measurement. Therefore, it is advantageous to skip the ANR measurement of a cell which is the same as the target cell re-selection cell. This can help the UE to save unnecessary power consumption and also speed up the cell re-selection procedure.

Conversely, if the UE also has to carry out the ANR measurement of cell1, then the cell reselection procedure will be delayed. The UE can also be configured to perform only the ANR measurement and skip the cell change procedure such as, for example, to ensure the UE measures and stores ANR measurement. One example situation is where it is considered critical for knowing new cells (e.g., cell2) added in the network. In yet another example, the UE may be configured not to perform ANR measurement nor perform ANR measurement. This is to prevent any error in the UE in acquiring ANR measurement results or delaying the cell change.

Examples of such configurations to prioritize between the two procedures are shown in the examples in Tables 3 and 4. Specifically, Table 3 is a first example for configuring a UE to perform ANR or cell change procedures in scenario A when the ANR measurement and cell change are performed on the same cell.

TABLE 3

| | Perform ANR | Perform Cell |
|---|---|---|
| Configuration ID | measurement | change procedure |
| 0 | YES | NO |
| 1 | NO | YES |

Table 4 is a second example for configuring a UE to perform ANR or cell change procedures in scenario A when the ANR measurement and cell change are performed on the same cell.

TABLE 4

| | Perform ANR | Perform cell change |
|---|---|---|
| Configuration ID | measurement on cell2 | procedure to cell2 |
| 0 | YES | NO |
| 1 | NO | YES |
| 2 | NO | NO |

Scenario B: Cell Re-Selection Cell is Different from ANR Cell:

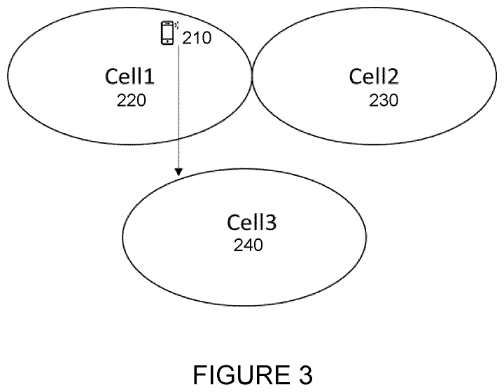

In scenario B, it is assumed that the UE is currently served by cell1 and it has found a cell (cell2) which has fulfilled the criteria for ANR measurement. Examples of such criteria are the PCI of that cell (cell2) is part of the white list which the network node is interested in, the PCI of that cell (e.g. cell2) does not belong to the black list that the network node is not interested in, etc. It is further assumed that the cell change criteria (e.g. cell re-selection criteria) is also met wherein the UE has found a third cell (cell3) as a target cell for the cell change (e.g. cell re-selection from cell1 to cell3). As such, the target ANR cell and the target cell for the cell change (e.g. cell re-selection cell) are not the same. FIG. 3 illustrates this scenario B where a UE 210 served in a first cell (cell1) 220 and where the target ANR cell (cell2) 230 and the target cell (cell3) 240 for the cell change (e.g., re-selection) are not the same, according to certain embodiments.

The UE behavior for this scenario is currently not defined in the specification and not known. The two procedures (ANR measurement and cell change procedures) can be triggered at the same time or during partially overlapping time as described earlier. As described above, the main difference between the scenario A and scenario B is that in scenario B the target cells for the two procedures are different.

In this case, the UE behavior can be determined based on one or more rules. The rule(s) can be signaled from the serving network node to the UE (e.g. in system information) or the rule(s) can be pre-defined in the specification with different options according to which the UE acts.

According to certain embodiments, the UE may prioritize the cell change procedure (e.g. cell re-selection procedure) over the ANR measurement. For example, the UE may first perform the cell re-selection procedure to cell3 and thereafter perform the ANR measurements on cell2 from the re-selected cell. In one example, the UE may continue with ANR measurements from already started ANR measurements from cell2. Generally, acquiring of ECGI requires the UE to read and combining numerous redundancy versions (RVs) of MIB and SIB1. In this example, it is assumed that UE continues attempting acquiring ECGI using already acquired RVs from cell2 without flushing its buffer after cell re-selection. The main advantage is that this will help the UE to acquire the ECGI of cell3 in shorter time compared to if the UE has to restart the procedure from cell3 after cell re-selection. This can, in turn, reduce unnecessary power consumption in the UE.

In a second example, it is assumed that the UE empties its buffer and restarts the ANR measurement of cell2 from cell3. The main reason for this can be, for example, different UE capability such as, for example, a limitation in a UE hardware. In the first option, the requirement for at least the ANR measurement may have to be relaxed. For example, by relaxation it means extending the time with regard to reference measurement time over which ANR measurement procedure is executed or performed. As used herein, the reference measurement time refers to the duration when only one procedure (ANR measurement is performed at a time i.e. only criteria for the ANR procedure is triggered. For example, assume that the ANR measurement can be performed over 800 ms in case the UE does not trigger any cell change procedure while doing the ANR measurement. This is called reference measurement time. As an example, the ANR measurement time or period can be extended from 800 ms (reference measurement time) to Tnew-anr (where Tnew-anr=800 ms+ΔT1 (e.g. Tnew-anr=2000 ms)) in case the UE is configured to prioritize the cell change over ANR measurements. The value of ΔT1 may depend on the time to perform cell change.

According to certain other embodiments, the UE may prioritize the ANR measurement such that the UE may first perform the ANR measurement on cell2 before performing the cell re-selection procedure to cell3. Cell re-selection criteria depends on the measured RRM measurement levels and quality. In case of NB-IoT, and according to 3GPP TS 36.304, the cell selection criterion S in normal coverage is fulfilled when:

$$Srxlev > 0 AND Squal > 0$$

$$where \text{:}$$

$$Srxlev = {Q}_{rxlevmeas} - ( {Q}_{rxlevmin} + {Q}_{rxlevminoffset} ) - Pcompensa$$

$${Qoffset}_{temp}$$

$$Squal = {Q}_{qualmeas} - ( {Q}_{qualmin} + {Q}_{qualminoffset} ) - {Qoffset}_{teemp}$$

Qᵣₓₗₑᵥₘₑₐₛ and Q_{qualmeas} are referred signal strength measurement (e.g. NRSRP) value and signal quality measurement (e.g. NRSRQ) value. This means, the cell selection criterion can be met by a certain margin such as, for example, X dB. In one example, X can be very small such as, for example, 1 dB meaning that the cell re-selection should not be delayed. In other example, X can be large value such as, for example, 5 dB, such that there is still some room for delaying the intended cell re-selection procedure. In this case, based upon this information, the UE may choose to first perform the ANR measurement of cell2 and later perform the cell re-selection procedure.

In such embodiments, the requirement for at least the cell change procedure (e.g. cell reselection) may have to be relaxed. As used herein, relaxation may mean extending the time associated with a reference cell change time over which cell change procedure is executed or performed. As used herein, the reference cell change time may refer to the duration when only one procedure (cell change is performed at a time i.e. only criteria for the cell change procedure is triggered. For example assume that the cell change can be performed over 2000 ms in case the UE does not trigger any ANR measurement procedure while doing the cell change. This is called reference cell change time. As an example, the cell change procedure delay or period or duration can be extended from 2000 ms (reference cell change time) to Tnew-cc (where Tnew-cc=2000 ms+ΔT2 (e.g. Tnew-ss=3000 ms)) in case the UE is configured to prioritize the ANR measurements over cell change procedure as in 2^{nd} option. The value of ΔT2 may depend on the time to perform the ANR measurements.

According to still other embodiments, the UE may skip the ANR measurement on cell2 and instead only perform the cell re-selection procedure to cell3. The motivation of this behavior may be that cell2 may or may not be part of the white list in cell3 such that, for example, the ANR measurement conditions for cell2 are met based on the information obtained from cell1 and it may not be relevant or it may not be the same in cell3. As such, it may be better to skip performing the ANR measurement on cell2 based on current triggering conditions. Instead, the UE may re-evaluate the ANR criteria from the new cell (cell3). If the conditions are met again, then the UE may start performing the ANR measurement on the same cell (cell2).

According to yet other embodiments, the UE may skip the cell re-selection procedure, perform the ANR measurement on cell2, and then re-evaluate the cell re-selection criteria. Performing the ANR measurements includes acquiring of, for example, ECGI which can take some time (e.g. X ms) since the UE needs to read and combine MIB and SIB1-NB. According to certain embodiments, X can be quite long especially in extended coverage such as, for example, when the UE is operating in the low Signal to Noise Ratio (SNR) regions. Upon completion of the ANR measurement procedure, cell3 may no longer be relevant for cell re-selection. For example, the radio conditions, signal strength, and quality measurements can change over time, and after X ms, the UE may no longer meet the cell re-selection criterion to cell3. Therefore it is better to re-evaluate the cell re-selection criterion again.

According to still other embodiments, the UE may take into account the carrier frequency of the target cell (cell3) with respect to carrier frequency of target ANR cell (cell2) in determining the priority order. For example, if cell3 is an intra-frequency cell such that cell2 and cell3 belong to the same carrier frequency, then the UE may perform the ANR measurement first and thereafter perform or re-evaluate the cell re-selection criteria. The motivation for this act is that since cell2 and cell3 belong to the same frequency (i.e. intra-frequency), it is very likely that cell2 might be part of the whitelist in cell3 such that the serving network of cell3 is likely to build a relation with cell2. On the other hand, if cell2 and cell3 belong to different frequencies (e.g. inter-frequency) or even different RAT (i.e. inter-RAT frequency), the UE may choose to first carry out the cell change (e.g. cell re-selection procedure) to cell3 and then perform ANR measurement of cell2 only if ANR measurement criteria is met in the new cell. The motivation for this option is that, if cell2 and cell3 belong to different frequencies or RAT, they may not be part of the same network such as, for example, they may even belong to different operators. Therefore, it is less likely that those cells will be part of the white list or less likely that network would be interested in building a relation with towards that cell.

According to still other embodiments, the UE may take into account the carrier frequency of the target cell (cell2) for ANR measurements and/or cell3 for the cell change with respect to carrier frequency of the serving cell (cell1). For example, if cell1 and cell2 belong to the same carrier frequency, then the UE may prioritize the cell change (e. g cell reselection procedure) to cell2 over ANR measurement on cell2 regardless of the frequency of cell2. This may be because the cell change on intra-frequency carrier may be more critical from the mobility perspective as compared to inter-frequency carrier.

The examples of the various options described above are expressed in Table 5, which shows examples of configuring UE to perform ANR and/or cell change procedures in scenario B (when ANR measurement and cell change are performed on different cells). For example, the first, second, third and fourth options are represented by configuration IDs #0, #1, #2 and #3 respectively. The fifth option is represented by configuration IDs 4 # and #5, respectively. The sixth option is represented by configuration ID #6, respectively.

TABLE 5

| | Perform ANR | Perform Cell change |
|---|---|---|
| Configuration ID | measurement on cell2 | procedure to cell3 |
| 0 | YES after cell change to cell3 | YES before ANR measurement on cell2 |
| 1 | YES before cell change to cell3 | YES after ANR measurement on cell2 |
| 2 | NO | YES |
| 3 | YES | NO |
| 4 | YES before cell change to cell3 | YES after ANR measurement on cell3 if |
| | if cell2 and cell3 belong to the | cell2 and cell3 belong to the same carrier |
| | same carrier frequency | frequency. |
| 5 | YES after cell change to cell2 if | YES before ANR measurement on cell2 |
| | cell2 and cell3 belong to | if cell2 and cell3 belong to the different |
| | different carrier frequency | carrier frequencies. |
| 6 | YES after cell change to cell2 if | YES before ANR measurement on cell2 |
| | cell1 and cell3 belong to the | if cell1 and cell3 belong to the same |
| | same carrier frequency | carrier frequency. |

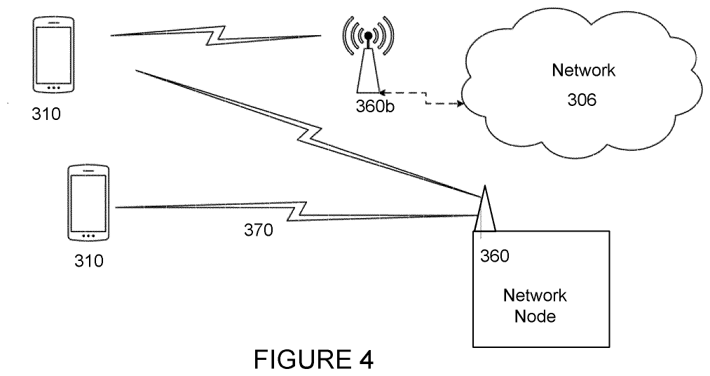

FIG. 4 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 306, network nodes 360 and 360b, and wireless devices 310, 310b, and 310c. In practice, a wireless network may further include any additional elements suitable to support communication between wireless devices or between a wireless device and another communication device, such as a landline telephone, a service provider, or any other network node or end device. Of the illustrated components, network node 360 and wireless device 310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 360 and wireless device 310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

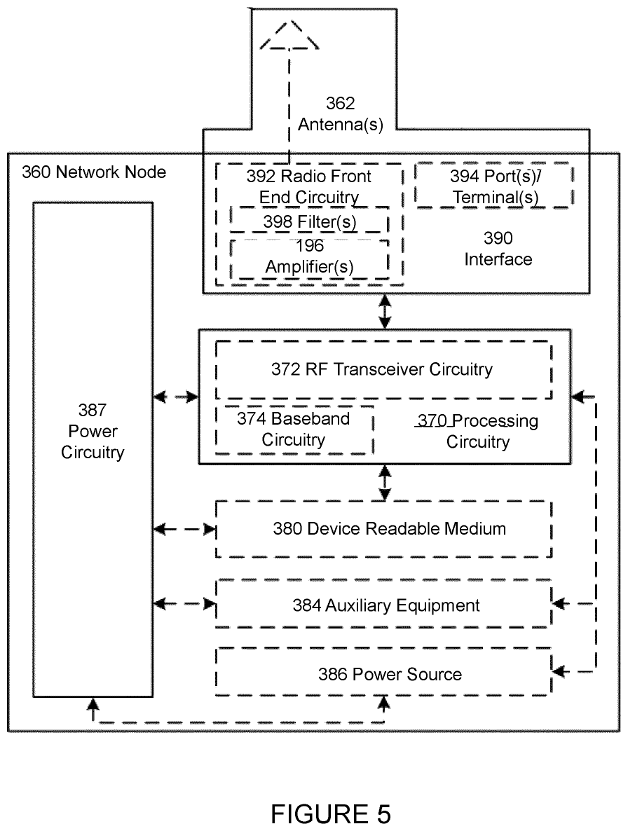

FIG. 5 illustrates an example network node 360, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 360 includes processing circuitry 370, device readable medium 380, interface 390, auxiliary equipment 384, power source 386, power circuitry 387, and antenna 362. Although network node 360 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 360 are depicted as single boxes located within a larger box, or nested within multiple boxes, in practice, a network node may comprise multiple different physical components that make up a single illustrated component (e.g., device readable medium 380 may comprise multiple separate hard drives as well as multiple RAM modules).

Similarly, network node 360 may be composed of multiple physically separate components (e.g., a NodeB component and a RNC component, or a BTS component and a BSC component, etc.), which may each have their own respective components. In certain scenarios in which network node 360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 360 may be configured to support multiple radio access technologies (RATs). In such embodiments, some components may be duplicated (e.g., separate device readable medium 380 for the different RATs) and some components may be reused (e.g., the same antenna 362 may be shared by the RATs). Network node 360 may also include multiple sets of the various illustrated components for different wireless technologies integrated into network node 360, such as, for example, GSM, Wide Code Division Multiplexing Access (WCDMA), LTE, NR, WiFi, or Bluetooth wireless technologies. These wireless technologies may be integrated into the same or different chip or set of chips and other components within network node 360.

Processing circuitry 370 is configured to perform any determining, calculating, or similar operations (e.g., certain obtaining operations) described herein as being provided by a network node. These operations performed by processing circuitry 370 may include processing information obtained by processing circuitry 370 by, for example, converting the obtained information into other information, comparing the obtained information or converted information to information stored in the network node, and/or performing one or more operations based on the obtained information or converted information, and as a result of said processing making a determination.

Processing circuitry 370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 360 components, such as device readable medium 380, network node 360 functionality. For example, processing circuitry 370 may execute instructions stored in device readable medium 380 or in memory within processing circuitry 370. Such functionality may include providing any of the various wireless features, functions, or benefits discussed herein. In some embodiments, processing circuitry 370 may include a system on a chip (SOC).

In some embodiments, processing circuitry 370 may include one or more of radio frequency (RF) transceiver circuitry 372 and baseband processing circuitry 374. In some embodiments, radio frequency (RF) transceiver circuitry 372 and baseband processing circuitry 374 may be on separate chips (or sets of chips), boards, or units, such as radio units and digital units. In alternative embodiments, part or all of RF transceiver circuitry 372 and baseband processing circuitry 374 may be on the same chip or set of chips, boards, or units.

In certain embodiments, some or all of the functionality described herein as being provided by a network node, base station, eNB or other such network device may be performed by processing circuitry 370 executing instructions stored on device readable medium 380 or memory within processing circuitry 370. In alternative embodiments, some or all of the functionality may be provided by processing circuitry 370 without executing instructions stored on a separate or discrete device readable medium, such as in a hard-wired manner. In any of those embodiments, whether executing instructions stored on a device readable storage medium or not, processing circuitry 370 can be configured to perform the described functionality. The benefits provided by such functionality are not limited to processing circuitry 370 alone or to other components of network node 360 but are enjoyed by network node 360 as a whole, and/or by end users and the wireless network generally.

Device readable medium 380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 370. Device readable medium 380 may store any suitable instructions, data or information, including a computer program, software, an application including one or more of logic, rules, code, tables, etc. and/or other instructions capable of being executed by processing circuitry 370 and, utilized by network node 360. Device readable medium 380 may be used to store any calculations made by processing circuitry 370 and/or any data received via interface 390. In some embodiments, processing circuitry 370 and device readable medium 380 may be considered to be integrated.

Interface 390 is used in the wired or wireless communication of signalling and/or data between network node 360, network 306, and/or wireless devices 310. As illustrated, interface 390 comprises port(s)/terminal(s) 394 to send and receive data, for example to and from network 306 over a wired connection. Interface 390 also includes radio front end circuitry 392 that may be coupled to, or in certain embodiments a part of, antenna 362. Radio front end circuitry 392 comprises filters 398 and amplifiers 396. Radio front end circuitry 392 may be connected to antenna 362 and processing circuitry 370. Radio front end circuitry may be configured to condition signals communicated between antenna 362 and processing circuitry 370. Radio front end circuitry 392 may receive digital data that is to be sent out to other network nodes or wireless devices via a wireless connection. Radio front end circuitry 392 may convert the digital data into a radio signal having the appropriate channel and bandwidth parameters using a combination of filters 398 and/or amplifiers 396. The radio signal may then be transmitted via antenna 362. Similarly, when receiving data, antenna 362 may collect radio signals which are then converted into digital data by radio front end circuitry 392. The digital data may be passed to processing circuitry 370. In other embodiments, the interface may comprise different components and/or different combinations of components.

In certain alternative embodiments, network node 360 may not include separate radio front end circuitry 392, instead, processing circuitry 370 may comprise radio front end circuitry and may be connected to antenna 362 without separate radio front end circuitry 392. Similarly, in some embodiments, all or some of RF transceiver circuitry 372 may be considered a part of interface 390. In still other embodiments, interface 390 may include one or more ports or terminals 394, radio front end circuitry 392, and RF transceiver circuitry 372, as part of a radio unit (not shown), and interface 390 may communicate with baseband processing circuitry 374, which is part of a digital unit (not shown).

Antenna 362 may include one or more antennas, or antenna arrays, configured to send and/or receive wireless signals. Antenna 362 may be coupled to radio front end circuitry 390 and may be any type of antenna capable of transmitting and receiving data and/or signals wirelessly. In some embodiments, antenna 362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 362 may be separate from network node 360 and may be connectable to network node 360 through an interface or port.

Antenna 362, interface 390, and/or processing circuitry 370 may be configured to perform any receiving operations and/or certain obtaining operations described herein as being performed by a network node. Any information, data and/or signals may be received from a wireless device, another network node and/or any other network equipment. Similarly, antenna 362, interface 390, and/or processing circuitry 370 may be configured to perform any transmitting operations described herein as being performed by a network node. Any information, data and/or signals may be transmitted to a wireless device, another network node and/or any other network equipment.

Power circuitry 387 may comprise, or be coupled to, power management circuitry and is configured to supply the components of network node 360 with power for performing the functionality described herein. Power circuitry 387 may receive power from power source 386. Power source 386 and/or power circuitry 387 may be configured to provide power to the various components of network node 360 in a form suitable for the respective components (e.g., at a voltage and current level needed for each respective component). Power source 386 may either be included in, or external to, power circuitry 387 and/or network node 360. For example, network node 360 may be connectable to an external power source (e.g., an electricity outlet) via an input circuitry or interface such as an electrical cable, whereby the external power source supplies power to power circuitry 387. As a further example, power source 386 may comprise a source of power in the form of a battery or battery pack which is connected to, or integrated in, power circuitry 387. The battery may provide backup power should the external power source fail. Other types of power sources, such as photovoltaic devices, may also be used.

Alternative embodiments of network node 360 may include additional components beyond those shown in FIG. 5 that may be responsible for providing certain aspects of the network node's functionality, including any of the functionality described herein and/or any functionality necessary to support the subject matter described herein. For example, network node 360 may include user interface equipment to allow input of information into network node 360 and to allow output of information from network node 360. This may allow a user to perform diagnostic, maintenance, repair, and other administrative functions for network node 360.

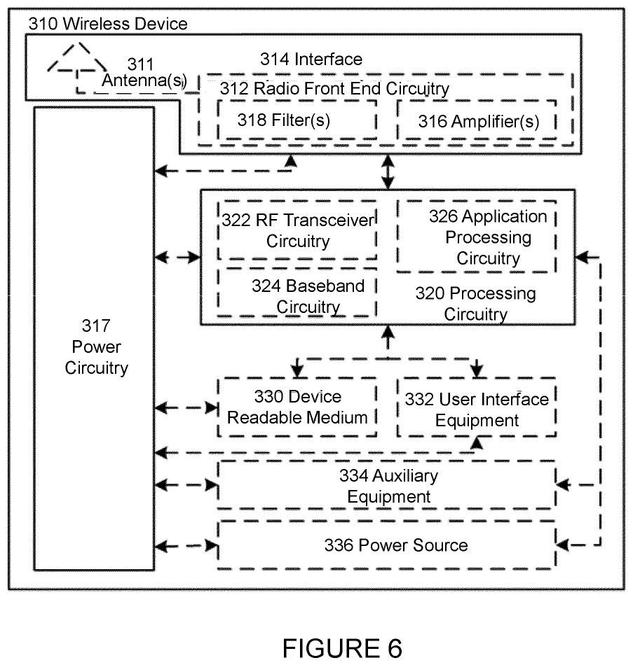

FIG. 6 illustrates an example wireless device 310, according to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 310 includes antenna 311, interface 314, processing circuitry 320, device readable medium 330, user interface equipment 332, auxiliary equipment 334, power source 336 and power circuitry 337. Wireless device 310 may include multiple sets of one or more of the illustrated components for different wireless technologies supported by wireless device 310, such as, for example, GSM, WCDMA, LTE, NR, WiFi, WiMAX, or Bluetooth wireless technologies, just to mention a few. These wireless technologies may be integrated into the same or different chips or set of chips as other components within wireless device 310.

Antenna 311 may include one or more antennas or antenna arrays, configured to send and/or receive wireless signals, and is connected to interface 314. In certain alternative embodiments, antenna 311 may be separate from wireless device 310 and be connectable to wireless device 310 through an interface or port. Antenna 311, interface 314, and/or processing circuitry 320 may be configured to perform any receiving or transmitting operations described herein as being performed by a wireless device. Any information, data and/or signals may be received from a network node and/or another wireless device. In some embodiments, radio front end circuitry and/or antenna 311 may be considered an interface.

As illustrated, interface 314 comprises radio front end circuitry 312 and antenna 311. Radio front end circuitry 312 comprise one or more filters 318 and amplifiers 316. Radio front end circuitry 314 is connected to antenna 311 and processing circuitry 320 and is configured to condition signals communicated between antenna 311 and processing circuitry 320. Radio front end circuitry 312 may be coupled to or a part of antenna 311. In some embodiments, wireless device 310 may not include separate radio front end circuitry 312; rather, processing circuitry 320 may comprise radio front end circuitry and may be connected to antenna 311. Similarly, in some embodiments, some or all of RF transceiver circuitry 322 may be considered a part of interface 314. Radio front end circuitry 312 may receive digital data that is to be sent out to other network nodes or wireless devices via a wireless connection. Radio front end circuitry 312 may convert the digital data into a radio signal having the appropriate channel and bandwidth parameters using a combination of filters 318 and/or amplifiers 316. The radio signal may then be transmitted via antenna 311. Similarly, when receiving data, antenna 311 may collect radio signals which are then converted into digital data by radio front end circuitry 312. The digital data may be passed to processing circuitry 320. In other embodiments, the interface may comprise different components and/or different combinations of components.

Processing circuitry 320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 310 components, such as device readable medium 330, wireless device 310 functionality. Such functionality may include providing any of the various wireless features or benefits discussed herein. For example, processing circuitry 320 may execute instructions stored in device readable medium 330 or in memory within processing circuitry 320 to provide the functionality disclosed herein.

As illustrated, processing circuitry 320 includes one or more of RF transceiver circuitry 322, baseband processing circuitry 324, and application processing circuitry 326. In other embodiments, the processing circuitry may comprise different components and/or different combinations of components. In certain embodiments processing circuitry 320 of wireless device 310 may comprise a SOC. In some embodiments, RF transceiver circuitry 322, baseband processing circuitry 324, and application processing circuitry 326 may be on separate chips or sets of chips. In alternative embodiments, part or all of baseband processing circuitry 324 and application processing circuitry 326 may be combined into one chip or set of chips, and RF transceiver circuitry 322 may be on a separate chip or set of chips. In still alternative embodiments, part or all of RF transceiver circuitry 322 and baseband processing circuitry 324 may be on the same chip or set of chips, and application processing circuitry 326 may be on a separate chip or set of chips. In yet other alternative embodiments, part or all of RF transceiver circuitry 322, baseband processing circuitry 324, and application processing circuitry 326 may be combined in the same chip or set of chips. In some embodiments, RF transceiver circuitry 322 may be a part of interface 314. RF transceiver circuitry 322 may condition RF signals for processing circuitry 320.

In certain embodiments, some or all of the functionality described herein as being performed by a wireless device may be provided by processing circuitry 320 executing instructions stored on device readable medium 330, which in certain embodiments may be a computer-readable storage medium. In alternative embodiments, some or all of the functionality may be provided by processing circuitry 320 without executing instructions stored on a separate or discrete device readable storage medium, such as in a hard-wired manner. In any of those particular embodiments, whether executing instructions stored on a device readable storage medium or not, processing circuitry 320 can be configured to perform the described functionality. The benefits provided by such functionality are not limited to processing circuitry 320 alone or to other components of wireless device 310, but are enjoyed by wireless device 310 as a whole, and/or by end users and the wireless network generally.

Processing circuitry 320 may be configured to perform any determining, calculating, or similar operations (e.g., certain obtaining operations) described herein as being performed by a wireless device. These operations, as performed by processing circuitry 320, may include processing information obtained by processing circuitry 320 by, for example, converting the obtained information into other information, comparing the obtained information or converted information to information stored by wireless device 310, and/or performing one or more operations based on the obtained information or converted information, and as a result of said processing making a determination.

Device readable medium 330 may be operable to store a computer program, software, an application including one or more of logic, rules, code, tables, etc. and/or other instructions capable of being executed by processing circuitry 320. Device readable medium 330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 320. In some embodiments, processing circuitry 320 and device readable medium 330 may be considered to be integrated.

User interface equipment 332 may provide components that allow for a human user to interact with wireless device 310. Such interaction may be of many forms, such as visual, audial, tactile, etc. User interface equipment 332 may be operable to produce output to the user and to allow the user to provide input to wireless device 310. The type of interaction may vary depending on the type of user interface equipment 332 installed in wireless device 310. For example, if wireless device 310 is a smart phone, the interaction may be via a touch screen; if wireless device 310 is a smart meter, the interaction may be through a screen that provides usage (e.g., the number of gallons used) or a speaker that provides an audible alert (e.g., if smoke is detected). User interface equipment 332 may include input interfaces, devices and circuits, and output interfaces, devices and circuits. User interface equipment 332 is configured to allow input of information into wireless device 310 and is connected to processing circuitry 320 to allow processing circuitry 320 to process the input information. User interface equipment 332 may include, for example, a microphone, a proximity or other sensor, keys/buttons, a touch display, one or more cameras, a USB port, or other input circuitry. User interface equipment 332 is also configured to allow output of information from wireless device 310, and to allow processing circuitry 320 to output information from wireless device 310. User interface equipment 332 may include, for example, a speaker, a display, vibrating circuitry, a USB port, a headphone interface, or other output circuitry. Using one or more input and output interfaces, devices, and circuits, of user interface equipment 332, wireless device 310 may communicate with end users and/or the wireless network and allow them to benefit from the functionality described herein.

Auxiliary equipment 334 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 334 may vary depending on the embodiment and/or scenario.

Power source 336 may, in some embodiments, be in the form of a battery or battery pack. Other types of power sources, such as an external power source (e.g., an electricity outlet), photovoltaic devices or power cells, may also be used. wireless device 310 may further comprise power circuitry 337 for delivering power from power source 336 to the various parts of wireless device 310 which need power from power source 336 to carry out any functionality described or indicated herein. Power circuitry 337 may in certain embodiments comprise power management circuitry. Power circuitry 337 may additionally or alternatively be operable to receive power from an external power source; in which case wireless device 310 may be connectable to the external power source (such as an electricity outlet) via input circuitry or an interface such as an electrical power cable. Power circuitry 337 may also in certain embodiments be operable to deliver power from an external power source to power source 336. This may be, for example, for the charging of power source 336. Power circuitry 337 may perform any formatting, converting, or other modification to the power from power source 336 to make the power suitable for the respective components of wireless device 310 to which power is supplied.

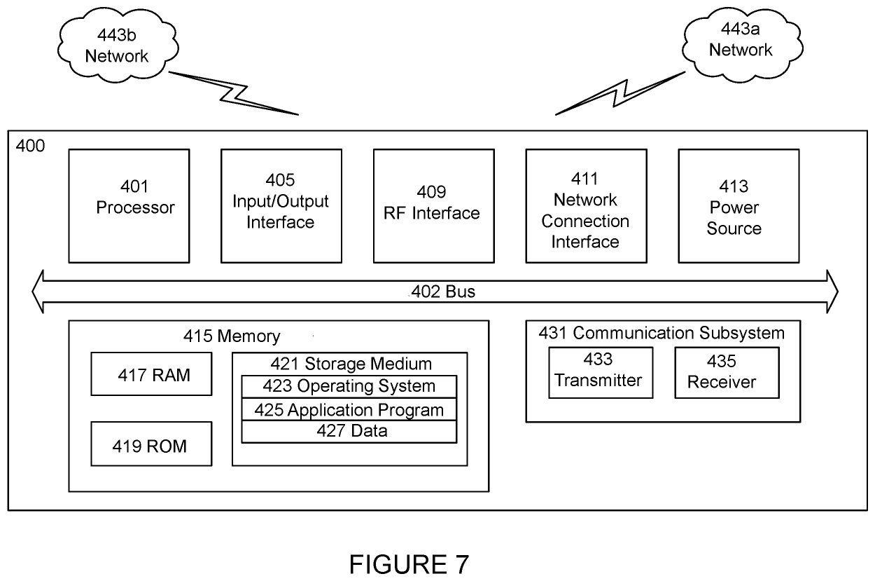

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 400 may be any UE identified by the 3^{rd} Generation Partnership Project (3GPP), including a NB-IoT UE, a machine type communication (MTC) UE, and/or an enhanced MTC (eMTC) UE. UE 400, as illustrated in FIG. 7, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 7 is a UE, the components discussed herein are equally applicable to a wireless device, and vice-versa.

In FIG. 7, UE 400 includes processing circuitry 401 that is operatively coupled to input/output interface 405, radio frequency (RF) interface 409, network connection interface 411, memory 415 including random access memory (RAM) 417, read-only memory (ROM) 419, and storage medium 421 or the like, communication subsystem 431, power source 433, and/or any other component, or any combination thereof. Storage medium 421 includes operating system 423, application program 425, and data 427. In other embodiments, storage medium 421 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 401 may be configured to process computer instructions and data. Processing circuitry 401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 401 may include two central processing units (CPUs). Data may be information in a form suitable for use by a computer.

In the depicted embodiment, input/output interface 405 may be configured to provide a communication interface to an input device, output device, or input and output device. UE 400 may be configured to use an output device via input/output interface 405. An output device may use the same type of interface port as an input device. For example, a USB port may be used to provide input to and output from UE 400. The output device may be a speaker, a sound card, a video card, a display, a monitor, a printer, an actuator, an emitter, a smartcard, another output device, or any combination thereof. UE 400 may be configured to use an input device via input/output interface 405 to allow a user to capture information into UE 400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 409 may be configured to provide a communication interface to RF components such as a transmitter, a receiver, and an antenna. Network connection interface 411 may be configured to provide a communication interface to network 443a. Network 443a may encompass wired and/or wireless networks such as a local-area network (LAN), a wide-area network (WAN), a computer network, a wireless network, a telecommunications network, another like network or any combination thereof. For example, network 443a may comprise a Wi-Fi network. Network connection interface 411 may be configured to include a receiver and a transmitter interface used to communicate with one or more other devices over a communication network according to one or more communication protocols, such as Ethernet, TCP/IP, SONET, ATM, or the like. Network connection interface 411 may implement receiver and transmitter functionality appropriate to the communication network links (e.g., optical, electrical, and the like). The transmitter and receiver functions may share circuit components, software or firmware, or alternatively may be implemented separately.

RAM 417 may be configured to interface via bus 402 to processing circuitry 401 to provide storage or caching of data or computer instructions during the execution of software programs such as the operating system, application programs, and device drivers. ROM 419 may be configured to provide computer instructions or data to processing circuitry 401. For example, ROM 419 may be configured to store invariant low-level system code or data for basic system functions such as basic input and output (I/O), startup, or reception of keystrokes from a keyboard that are stored in a non-volatile memory. Storage medium 421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 421 may be configured to include operating system 423, application program 425 such as a web browser application, a widget or gadget engine or another application, and data file 427. Storage medium 421 may store, for use by UE 400, any of a variety of various operating systems or combinations of operating systems.

Storage medium 421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 421 may allow UE 400 to access computer-executable instructions, application programs or the like, stored on transitory or non-transitory memory media, to off-load data, or to upload data. An article of manufacture, such as one utilizing a communication system may be tangibly embodied in storage medium 421, which may comprise a device readable medium.

In FIG. 7, processing circuitry 401 may be configured to communicate with network 443b using communication subsystem 431. Network 443a and network 443b may be the same network or networks or different network or networks. Communication subsystem 431 may be configured to include one or more transceivers used to communicate with network 443b. For example, communication subsystem 431 may be configured to include one or more transceivers used to communicate with one or more remote transceivers of another device capable of wireless communication such as another wireless device, UE, or base station of a radio access network (RAN) according to one or more communication protocols, such as IEEE 802.4, CDMA, WCDMA, GSM, LTE, UTRAN, WiMax, or the like. Each transceiver may include transmitter 433 and/or receiver 435 to implement transmitter or receiver functionality, respectively, appropriate to the RAN links (e.g., frequency allocations and the like). Further, transmitter 433 and receiver 435 of each transceiver may share circuit components, software or firmware, or alternatively may be implemented separately.

In the illustrated embodiment, the communication functions of communication subsystem 431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 431 may include cellular communication, Wi-Fi communication, Bluetooth communication, and GPS communication. Network 443b may encompass wired and/or wireless networks such as a local-area network (LAN), a wide-area network (WAN), a computer network, a wireless network, a telecommunications network, another like network or any combination thereof. For example, network 443b may be a cellular network, a Wi-Fi network, and/or a near-field network. Power source 413 may be configured to provide alternating current (AC) or direct current (DC) power to components of UE 400.

The features, benefits and/or functions described herein may be implemented in one of the components of UE 400 or partitioned across multiple components of UE 400. Further, the features, benefits, and/or functions described herein may be implemented in any combination of hardware, software or firmware. In one example, communication subsystem 431 may be configured to include any of the components described herein. Further, processing circuitry 401 may be configured to communicate with any of such components over bus 402. In another example, any of such components may be represented by program instructions stored in memory that when executed by processing circuitry 401 perform the corresponding functions described herein. In another example, the functionality of any of such components may be partitioned between processing circuitry 401 and communication subsystem 431. In another example, the non-computationally intensive functions of any of such components may be implemented in software or firmware and the computationally intensive functions may be implemented in hardware.

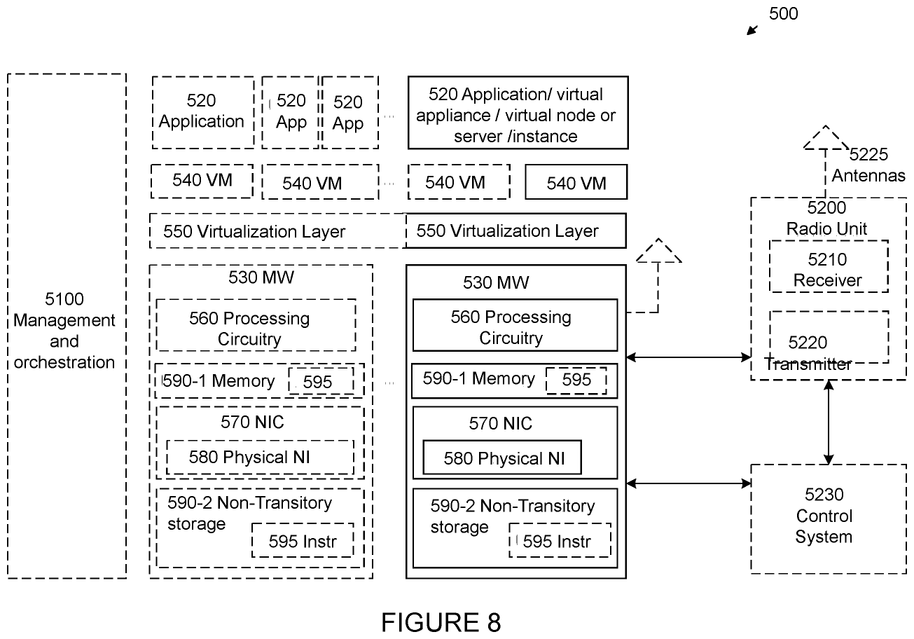

FIG. 8 is a schematic block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 500 hosted by one or more of hardware nodes 530. Further, in embodiments in which the virtual node is not a radio access node or does not require radio connectivity (e.g., a core network node), then the network node may be entirely virtualized.

The functions may be implemented by one or more applications 520 (which may alternatively be called software instances, virtual appliances, network functions, virtual nodes, virtual network functions, etc.) operative to implement some of the features, functions, and/or benefits of some of the embodiments disclosed herein. Applications 520 are run in virtualization environment 500 which provides hardware 530 comprising processing circuitry 560 and memory 590. Memory 590 contains instructions 595 executable by processing circuitry 560 whereby application 520 is operative to provide one or more of the features, benefits, and/or functions disclosed herein.

Virtualization environment 500, comprises general-purpose or special-purpose network hardware devices 530 comprising a set of one or more processors or processing circuitry 560, which may be commercial off-the-shelf (COTS) processors, dedicated Application Specific Integrated Circuits (ASICs), or any other type of processing circuitry including digital or analog hardware components or special purpose processors. Each hardware device may comprise memory 590-1 which may be non-persistent memory for temporarily storing instructions 595 or software executed by processing circuitry 560. Each hardware device may comprise one or more network interface controllers (NICs) 570, also known as network interface cards, which include physical network interface 580. Each hardware device may also include non-transitory, persistent, machine-readable storage media 590-2 having stored therein software 595 and/or instructions executable by processing circuitry 560. Software 595 may include any type of software including software for instantiating one or more virtualization layers 550 (also referred to as hypervisors), software to execute virtual machines 540 as well as software allowing it to execute functions, features and/or benefits described in relation with some embodiments described herein.

Virtual machines 540, comprise virtual processing, virtual memory, virtual networking or interface and virtual storage, and may be run by a corresponding virtualization layer 550 or hypervisor. Different embodiments of the instance of virtual appliance 520 may be implemented on one or more of virtual machines 540, and the implementations may be made in different ways.

During operation, processing circuitry 560 executes software 595 to instantiate the hypervisor or virtualization layer 550, which may sometimes be referred to as a virtual machine monitor (VMM). Virtualization layer 550 may present a virtual operating platform that appears like networking hardware to virtual machine 540.

As shown in FIG. 8, hardware 530 may be a standalone network node with generic or specific components. Hardware 530 may comprise antenna 5225 and may implement some functions via virtualization. Alternatively, hardware 530 may be part of a larger cluster of hardware (e.g. such as in a data center or customer premise equipment (CPE)) where many hardware nodes work together and are managed via management and orchestration (MANO) 5100, which, among others, oversees lifecycle management of applications 520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 540 may be a software implementation of a physical machine that runs programs as if they were executing on a physical, non-virtualized machine. Each of virtual machines 540, and that part of hardware 530 that executes that virtual machine, be it hardware dedicated to that virtual machine and/or hardware shared by that virtual machine with others of the virtual machines 540, forms a separate virtual network elements (VNE).

Still in the context of NFV, Virtual Network Function (VNF) is responsible for handling specific network functions that run in one or more virtual machines 540 on top of hardware networking infrastructure 530 and corresponds to application 520 in FIG. 8.

In some embodiments, one or more radio units 5200 that each include one or more transmitters 5220 and one or more receivers 5210 may be coupled to one or more antennas 5225. Radio units 5200 may communicate directly with hardware nodes 530 via one or more appropriate network interfaces and may be used in combination with the virtual components to provide a virtual node with radio capabilities, such as a radio access node or a base station.

In some embodiments, some signaling can be affected with the use of control system 5230 which may alternatively be used for communication between the hardware nodes 530 and radio units 5200.

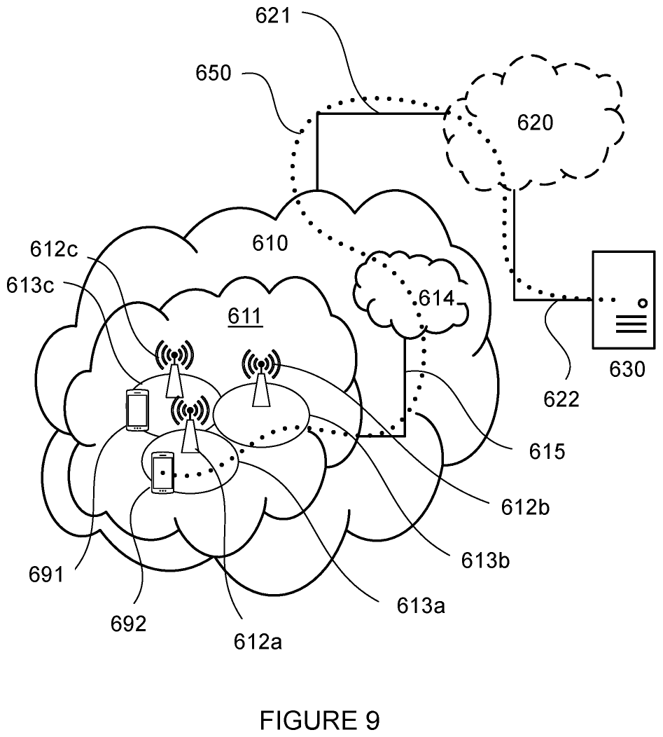

FIG. 9 illustrates a telecommunication network connected via an intermediate network to a host computer in accordance with some embodiments. With reference to FIG. 9, in accordance with an embodiment, a communication system includes telecommunication network 610, such as a 3GPP-type cellular network, which comprises access network 611, such as a radio access network, and core network 614. Access network 611 comprises a plurality of base stations 612a, 612b, 612c, such as NBs, eNBs, gNBs or other types of wireless access points, each defining a corresponding coverage area 613a, 613b, 613c. Each base station 612a, 612b, 612c is connectable to core network 614 over a wired or wireless connection 615. A first UE 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612.

Telecommunication network 610 is itself connected to host computer 630, which may be embodied in the hardware and/or software of a standalone server, a cloud-implemented server, a distributed server or as processing resources in a server farm. Host computer 630 may be under the ownership or control of a service provider or may be operated by the service provider or on behalf of the service provider. Connections 621 and 622 between telecommunication network 610 and host computer 630 may extend directly from core network 614 to host computer 630 or may go via an optional intermediate network 620. Intermediate network 620 may be one of, or a combination of more than one of, a public, private or hosted network; intermediate network 620, if any, may be a backbone network or the Internet; in particular, intermediate network 620 may comprise two or more sub-networks (not shown).

The communication system of FIG. 9 as a whole enables connectivity between the connected UEs 691, 692 and host computer 630. The connectivity may be described as an over-the-top (OTT) connection 650. Host computer 630 and the connected UEs 691, 692 are configured to communicate data and/or signaling via OTT connection 650, using access network 611, core network 614, any intermediate network 620 and possible further infrastructure (not shown) as intermediaries. OTT connection 650 may be transparent in the sense that the participating communication devices through which OTT connection 650 passes are unaware of routing of uplink and downlink communications. For example, base station 612 may not or need not be informed about the past routing of an incoming downlink communication with data originating from host computer 630 to be forwarded (e.g., handed over) to a connected UE 691. Similarly, base station 612 need not be aware of the future routing of an outgoing uplink communication originating from the UE 691 towards the host computer 630.

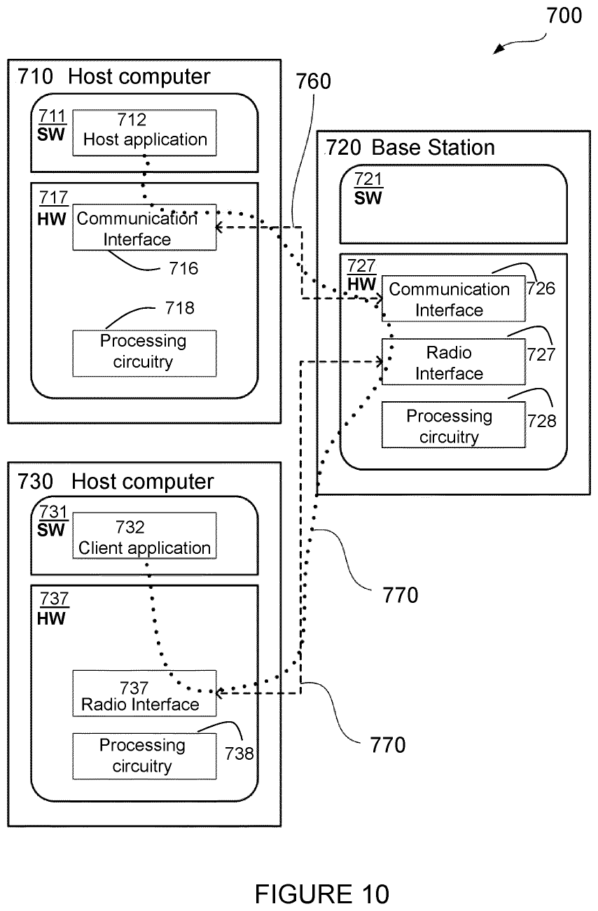

FIG. 10 illustrates a host computer communicating via a base station with a user equipment over a partially wireless connection in accordance with some embodiments. Example implementations, in accordance with an embodiment, of the UE, base station and host computer discussed in the preceding paragraphs will now be described with reference to FIG. 10. In communication system 700, host computer 710 comprises hardware 715 including communication interface 716 configured to set up and maintain a wired or wireless connection with an interface of a different communication device of communication system 700. Host computer 710 further comprises processing circuitry 718, which may have storage and/or processing capabilities. In particular, processing circuitry 718 may comprise one or more programmable processors, application-specific integrated circuits, field programmable gate arrays or combinations of these (not shown) adapted to execute instructions. Host computer 710 further comprises software 711, which is stored in or accessible by host computer 710 and executable by processing circuitry 718. Software 711 includes host application 712. Host application 712 may be operable to provide a service to a remote user, such as UE 730 connecting via OTT connection 750 terminating at UE 730 and host computer 710. In providing the service to the remote user, host application 712 may provide user data which is transmitted using OTT connection 750.

Communication system 700 further includes base station 720 provided in a telecommunication system and comprising hardware 725 enabling it to communicate with host computer 710 and with UE 730. Hardware 725 may include communication interface 726 for setting up and maintaining a wired or wireless connection with an interface of a different communication device of communication system 700, as well as radio interface 727 for setting up and maintaining at least wireless connection 770 with UE 730 located in a coverage area (not shown in FIG. 10) served by base station 720. Communication interface 726 may be configured to facilitate connection 760 to host computer 710. Connection 760 may be direct or it may pass through a core network (not shown in FIG. 10) of the telecommunication system and/or through one or more intermediate networks outside the telecommunication system. In the embodiment shown, hardware 725 of base station 720 further includes processing circuitry 728, which may comprise one or more programmable processors, application-specific integrated circuits, field programmable gate arrays or combinations of these (not shown) adapted to execute instructions. Base station 720 further has software 721 stored internally or accessible via an external connection.

Communication system 700 further includes UE 730 already referred to. Its hardware 735 may include radio interface 737 configured to set up and maintain wireless connection 770 with a base station serving a coverage area in which UE 730 is currently located. Hardware 735 of UE 730 further includes processing circuitry 738, which may comprise one or more programmable processors, application-specific integrated circuits, field programmable gate arrays or combinations of these (not shown) adapted to execute instructions. UE 730 further comprises software 731, which is stored in or accessible by UE 730 and executable by processing circuitry 738. Software 731 includes client application 732. Client application 732 may be operable to provide a service to a human or non-human user via UE 730, with the support of host computer 710. In host computer 710, an executing host application 712 may communicate with the executing client application 732 via OTT connection 750 terminating at UE 730 and host computer 710. In providing the service to the user, client application 732 may receive request data from host application 712 and provide user data in response to the request data. OTT connection 750 may transfer both the request data and the user data. Client application 732 may interact with the user to generate the user data that it provides.

It is noted that host computer 710, base station 720 and UE 730 illustrated in FIG. 10 may be similar or identical to host computer 630, one of base stations 612a, 612b, 612c and one of UEs 691, 692 of FIG. 9, respectively. This is to say, the inner workings of these entities may be as shown in FIG. 10 and independently, the surrounding network topology may be that of FIG. 9.

In FIG. 9, OTT connection 750 has been drawn abstractly to illustrate the communication between host computer 710 and UE 730 via base station 720, without explicit reference to any intermediary devices and the precise routing of messages via these devices. Network infrastructure may determine the routing, which it may be configured to hide from UE 730 or from the service provider operating host computer 710, or both. While OTT connection 750 is active, the network infrastructure may further take decisions by which it dynamically changes the routing (e.g., on the basis of load balancing consideration or reconfiguration of the network).

Wireless connection 770 between UE 730 and base station 720 is in accordance with the teachings of the embodiments described throughout this disclosure. One or more of the various embodiments improve the performance of OTT services provided to UE 730 using OTT connection 750, in which wireless connection 770 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 750 between host computer 710 and UE 730, in response to variations in the measurement results. The measurement procedure and/or the network functionality for reconfiguring OTT connection 750 may be implemented in software 711 and hardware 715 of host computer 710 or in software 731 and hardware 735 of UE 730, or both. In embodiments, sensors (not shown) may be deployed in or in association with communication devices through which OTT connection 750 passes; the sensors may participate in the measurement procedure by supplying values of the monitored quantities exemplified above or supplying values of other physical quantities from which software 711, 731 may compute or estimate the monitored quantities. The reconfiguring of OTT connection 750 may include message format, retransmission settings, preferred routing etc.; the reconfiguring need not affect base station 720, and it may be unknown or imperceptible to base station 720. Such procedures and functionalities may be known and practiced in the art. In certain embodiments, measurements may involve proprietary UE signaling facilitating host computer 710's measurements of throughput, propagation times, latency and the like. The measurements may be implemented in that software 711 and 731 causes messages to be transmitted, in particular empty or ‘dummy’ messages, using OTT connection 750 while it monitors propagation times, errors etc.

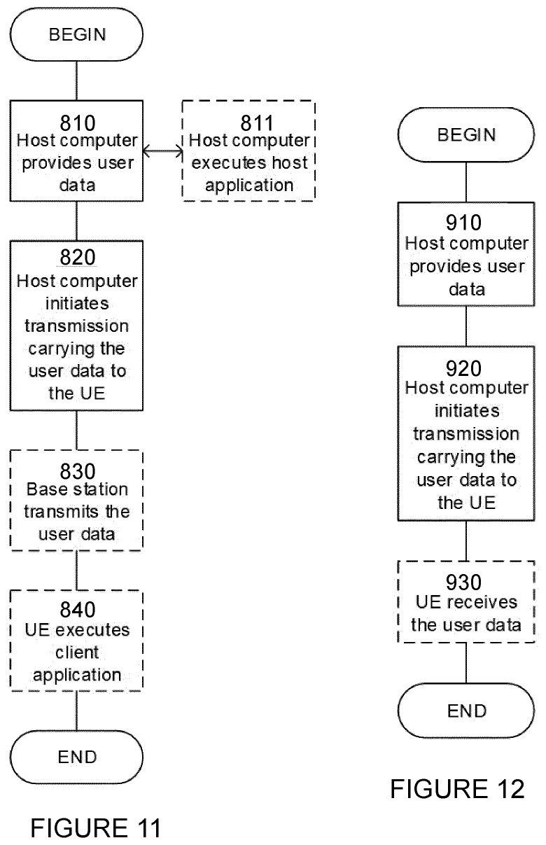

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 810, the host computer provides user data. In substep 811 (which may be optional) of step 810, the host computer provides the user data by executing a host application. In step 820, the host computer initiates a transmission carrying the user data to the UE. In step 830 (which may be optional), the base station transmits to the UE the user data which was carried in the transmission that the host computer initiated, in accordance with the teachings of the embodiments described throughout this disclosure. In step 840 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 910 of the method, the host computer provides user data. In an optional substep (not shown) the host computer provides the user data by executing a host application. In step 920, the host computer initiates a transmission carrying the user data to the UE. The transmission may pass via the base station, in accordance with the teachings of the embodiments described throughout this disclosure. In step 930 (which may be optional), the UE receives the user data carried in the transmission.

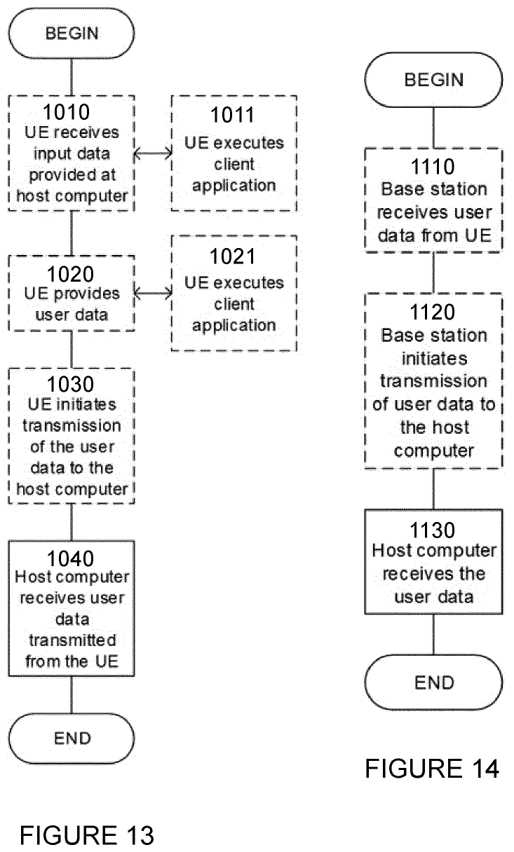

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1010 (which may be optional), the UE receives input data provided by the host computer. Additionally or alternatively, in step 1020, the UE provides user data. In substep 1021 (which may be optional) of step 1020, the UE provides the user data by executing a client application. In substep 1011 (which may be optional) of step 1010, the UE executes a client application which provides the user data in reaction to the received input data provided by the host computer. In providing the user data, the executed client application may further consider user input received from the user. Regardless of the specific manner in which the user data was provided, the UE initiates, in substep 1030 (which may be optional), transmission of the user data to the host computer. In step 1040 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1110 (which may be optional), in accordance with the teachings of the embodiments described throughout this disclosure, the base station receives user data from the UE. In step 1120 (which may be optional), the base station initiates transmission of the received user data to the host computer. In step 1130 (which may be optional), the host computer receives the user data carried in the transmission initiated by the base station.

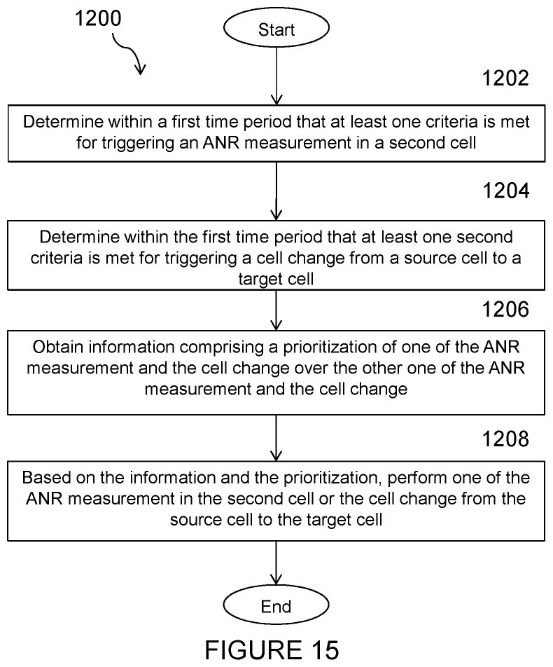

FIG. 15 depicts a method 1200 by a wireless device 310 served in a first cell, according to certain embodiments. In a particular embodiment, the wireless device 310 is a UE. At step 1202, the wireless device 310 determines within a first time period that at least one criteria is met for triggering an ANR measurement in a second cell. At step 1204, the wireless device 310 determines within the first time period that at least one second criteria is met for triggering a cell change from a source cell to a target cell. At step 1206, the wireless device 310 obtains information comprising a prioritization of one of the ANR measurement and the cell change over the other one of the ANR measurement and the cell change. At step 1208, based on the information and the prioritization, the wireless device 310 performs one of the ANR measurement in the second cell or the cell change from the source cell to the target cell.

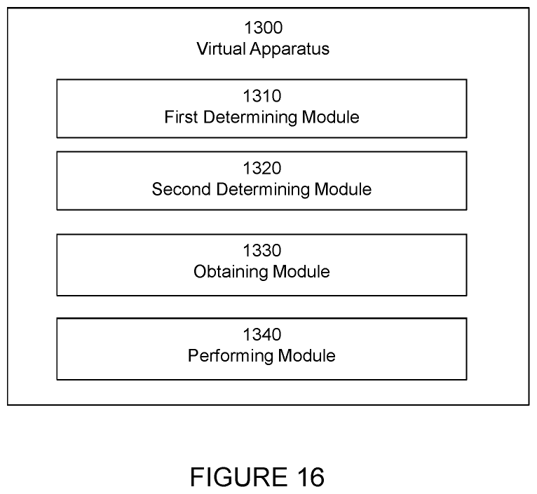

FIG. 16 illustrates a schematic block diagram of a virtual apparatus 1300 in a wireless network (for example, the wireless network shown in FIG. 4). The apparatus may be implemented in a wireless device or network node (e.g., wireless device 310 or network node 360 shown in FIG. 4). Apparatus 1300 is operable to carry out the example method described with reference to FIG. 15 and possibly any other processes or methods disclosed herein. It is also to be understood that the method of FIG. 15 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 1310, second determining module 1320, obtaining module 1330, performing module 1340, and any other suitable units of apparatus 1300 to perform corresponding functions according one or more embodiments of the present disclosure.

According to certain embodiments, first determining module 1310 may perform certain of the determining functions of the apparatus 1300. For example, first determining module 1310 may determine within a first time period that at least one criteria is met for triggering an ANR measurement in a second cell.

According to certain embodiments, second determining module 1320 may perform certain other of the determining functions of the apparatus 1300. For example, second determining module 1320 may determine within the first time period that at least one second criteria is met for triggering a cell change from a source cell to a target cell.

According to certain embodiments, obtaining module 1330 may perform certain of the obtaining functions of the apparatus 1300. For example, obtaining module 1330 may obtain information comprising a prioritization of one of the ANR measurement and the cell change over the other one of the ANR measurement and the cell change.

According to certain embodiments, performing module 1340 may perform certain of the performing functions of the apparatus 1300. For example, performing module 1340 may perform one of the ANR measurement in the second cell or the cell change from the source cell to the target cell based on the information and the prioritization.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

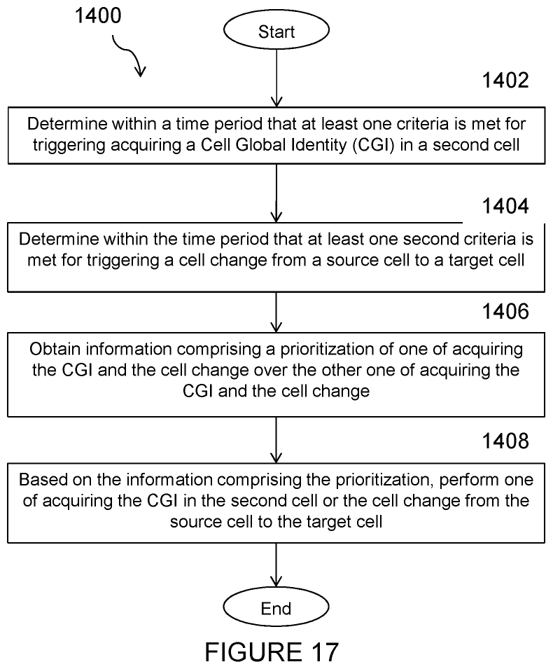

FIG. 17 depicts a method 1400 performed by a wireless device 310 served in a first cell, according to certain embodiments. In a particular embodiment, the wireless device 310 is a UE. At step 1402, the wireless device 310 determines within a time period that at least one criteria is met for triggering acquiring a CGI in a second cell. At step 1404, the wireless device 310 determines within the time period that at least one second criteria is met for triggering a cell change from a source cell to a target cell. At step 1406, the wireless device 310 obtains information comprising a prioritization of one of acquiring the CGI and the cell change over the other one of acquiring the CGI and the cell change. Based on the information comprising the prioritization, the wireless device 310 performs one of acquiring the CGI in the second cell or the cell change from the source cell to the target cell.

In a particular embodiment, the at least one criteria for triggering the procedure for acquiring the CGI includes a detection of a strong cell.

In a particular embodiment, the UE is an RRC state in which the UE autonomously switches from a source cell to a target cell.

In a particular embodiment, the RRC state comprises an RRC idle state or an RRC inactive state.

In a particular embodiment, the at least one criteria triggering the procedure for acquiring the CGI includes a comparison of a PCI of the second cell with information received from a network node.

In a particular embodiment, the at least one criteria triggering the procedure for acquiring the CGI includes the PCI of the second cell belonging to or being a part of a white list that a network node is interested in or the PCI of the second cell not belonging to or being a part of a black list that the network node is not interested.

In a particular embodiment, when obtaining the information comprising the prioritization, the wireless device 310 receives a signal from a network node 360 indicating that the UE is to prioritize acquiring the CGI or the cell change.

In a particular embodiment, the second cell is the same as the target cell. The information comprising the prioritization indicates: the procedure for acquiring the CGI should not be performed and the cell reselection should be performed; the procedure for acquiring the CGI should be performed and the cell reselection should be not be performed; or neither the procedure for acquiring the CGI nor the cell reselection should be performed.

In a particular embodiment, the second cell is not the same as the target cell, and the information comprising the prioritization indicates that the cell reselection should be performed before the CGI is acquired or the CGI should be acquired before the cell reselection is performed.

In a particular embodiment, the at least one criteria triggering the procedure for acquiring the CGI includes at least one criteria triggering an eCGI, reading.

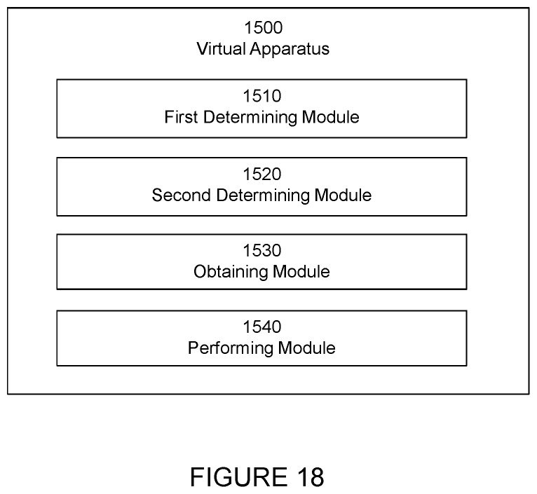

FIG. 18 illustrates a schematic block diagram of a virtual apparatus 1500 in a wireless network (for example, the wireless network shown in FIG. 4). The apparatus may be implemented in a wireless device or network node (e.g., wireless device 310 or network node 360 shown in FIG. 4). Apparatus 1500 is operable to carry out the example method described with reference to FIG. 17 and possibly any other processes or methods disclosed herein. It is also to be understood that the method of FIG. 17 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 1510, second determining module 1520, obtaining module 1530, performing module 1540, and any other suitable units of apparatus 1500 to perform corresponding functions according one or more embodiments of the present disclosure.

According to certain embodiments, first determining module 1510 may perform certain of the determining functions of the apparatus 1500. For example, first determining module 1510 may determine within a time period that at least one criteria is met for triggering acquiring a CGI in a second cell.

According to certain embodiments, second determining module 1520 may perform certain other of the determining functions of the apparatus 1500. For example, second determining module 1520 may determine within the time period that at least one second criteria is met for triggering a cell change from a source cell to a target cell.

According to certain embodiments, obtaining module 1530 may perform certain of the obtaining functions of the apparatus 1500. For example, obtaining module 1530 may obtain information comprising a prioritization of one of acquiring the CGI and the cell change over the other one of acquiring the CGI and the cell change.

According to certain embodiments, performing module 1540 may perform certain of the performing functions of the apparatus 1500. For example, based on the information comprising the prioritization, performing module 1540 may perform one of acquiring the CGI in the second cell or the cell change from the source cell to the target cell.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

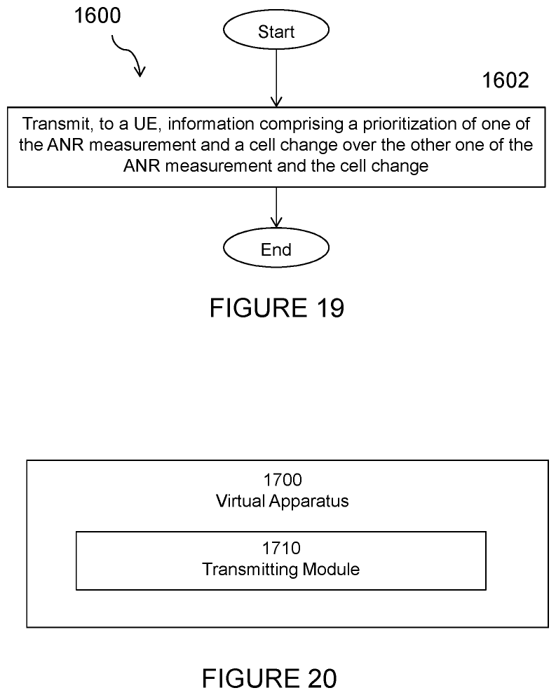

FIG. 19 depicts a method 1600 by a network node 360, according to certain embodiments. At step 1602, the network node 360 may transmit, to a UE, information comprising a prioritization of one of an ANR measurement and a cell change over the other one of the ANR measurement and the cell change.

FIG. 20 illustrates a schematic block diagram of a virtual apparatus 1700 in a wireless network (for example, the wireless network shown in FIG. 4). The apparatus may be implemented in a wireless device or network node (e.g., wireless device 310 or network node 360 shown in FIG. 4). Apparatus 1700 is operable to carry out the example method described with reference to FIG. 19 and possibly any other processes or methods disclosed herein. It is also to be understood that the method of FIG. 19 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1710 and any other suitable units of apparatus 1700 to perform corresponding functions according one or more embodiments of the present disclosure.

According to certain embodiments, transmitting module 1710 may perform certain of the transmitting functions of the apparatus 1700. For example, transmitting module 1710 may transmit, to a UE, information comprising a prioritization of one of an ANR measurement and a cell change over the other one of the ANR measurement and the cell change.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

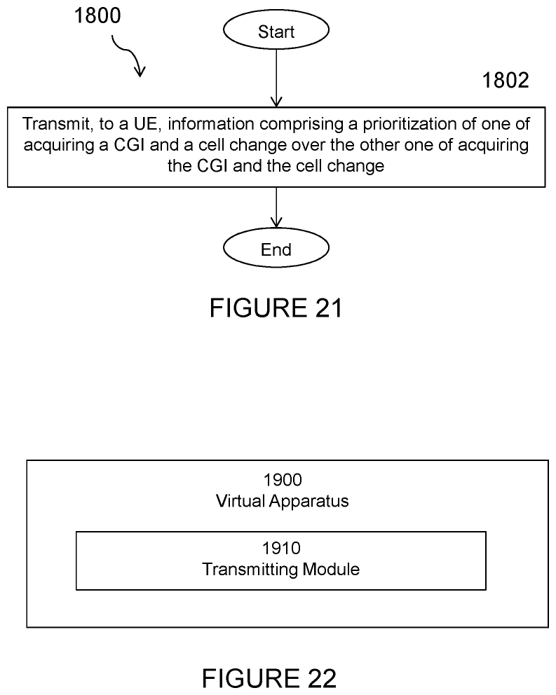

FIG. 21 depicts a method 1800 performed by a network node 360, according to certain embodiments. At step 1802, the network node 360 may transmit, to a UE, information comprising a prioritization of one of acquiring a CGI and a cell change over the other one of acquiring the CGI and the cell change.

In a particular embodiment, the UE is a RRC state in which the UE autonomously switches from a source cell to a target cell, and the RRC state comprises an RRC idle state or an RRC inactive state.

In a particular embodiment, acquiring the CGI is for a second cell, and the cell change is from a source cell to a target cell.

In a particular embodiment, the second cell is the same as the target cell, and the information comprising the prioritization indicates that: acquiring the CGI should not be performed and the cell reselection should be performed; acquiring the CGI should be performed and the cell reselection should not be performed; or neither acquiring the CGI nor the cell reselection should be performed.

In a particular embodiment, the second cell is not the same as the target cell, and the information comprising the prioritization indicates that: the cell reselection should be performed before acquiring the CGI is performed; or acquiring the CGI should be performed before the cell reselection is performed.

In a particular embodiment, the network node configures the UE with at least one criteria for triggering acquiring the CGI, and the at least one criteria comprising a detection of a strong cell by the UE.

In a particular embodiment, the network node configures the UE with at least one criteria for triggering acquiring the CGI, and the at least one criteria includes a comparison of a PCI of the second cell with PCI information received from the network node.

In a particular embodiment, the network node transmits the PCI information to the UE, and the PCI information includes a white list of at least one PCI of which the network node is interested or a black list of at least one PCI of which the network node is not interested.

In a particular embodiment, the procedure for acquiring the CGI is a procedure for performing a eCGI reading.

FIG. 22 illustrates a schematic block diagram of a virtual apparatus 1900 in a wireless network (for example, the wireless network shown in FIG. 4). The apparatus may be implemented in a wireless device or network node (e.g., wireless device 310 or network node 360 shown in FIG. 4). Apparatus 1900 is operable to carry out the example method described with reference to FIG. 21 and possibly any other processes or methods disclosed herein. It is also to be understood that the method of FIG. 21 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1910 and any other suitable units of apparatus 1900 to perform corresponding functions according one or more embodiments of the present disclosure.

According to certain embodiments, transmitting module 1910 may perform certain of the transmitting functions of the apparatus 1900. For example, transmitting module 1910 may transmit, to a UE, information comprising a prioritization of one of acquiring CGI and a cell change over the other one of acquiring CGI and the cell change.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### EXAMPLE EMBODIMENTS

Example Embodiment 1. A method performed by a UE served in a first cell, the method comprising: determining within a first time period that at least one criteria is met for triggering an ANR measurement in a second cell; determining within the first time period that at least one second criteria is met for triggering a cell change from a source cell to a target cell; obtaining information comprising a prioritization of one of the ANR measurement and the cell change over the other one of the ANR measurement and the cell change; based on the information and the prioritization, performing one of the ANR measurement in the second cell or the cell change from the source cell to the target cell.

Example Embodiment 2. The method of Embodiment 1, wherein the at least one criteria for triggering the ANR measurement comprises a detection of a strong cell.

Example Embodiment 3. The method of Embodiments 1 to 2, wherein the UE is an RRC state in which the UE autonomously switches from a source cell to a target cell.

Example Embodiment 4. The method of Embodiment 3, wherein the RRC state comprises an RRC connected state, an RRC idle state, an RRC idle state, or an RRC inactive state.

Example Embodiment 5. The method of any one of Embodiments 1 to 4, wherein the at least one criteria triggering the ANR measurement comprises a comparison of a PCI of the second cell with obtained information.

Example Embodiment 6. The method of Embodiment 5, wherein the obtained information is received from a network node.

Example Embodiment 7. The method of any one of Embodiments 1 to 6, wherein the at least one criteria triggering the ANR measurements comprises the PCI of the second cell is part of a white list that a network node is interested in or the PCI of the second cell does not belong to the black list that the network node is not interested.

Example Embodiment 8. The method of any one of Embodiments 1 to 7, wherein obtaining the information comprising the prioritization comprises receiving a signal from a network node.

Example Embodiment 9. The method of any one of Embodiments 1 to 8, wherein the second cell is the same as the target cell.

Example Embodiment 10. The method of Embodiment 9, wherein the information comprising the prioritization indicates that the ANR measurement should not be performed and the cell reselection should be performed.

Example Embodiment 11. The method of Embodiment 9, wherein the information comprising the prioritization indicates that the ANR measurement should be performed and the cell reselection should be not be performed.

Example Embodiment 12. The method Embodiment 9, wherein the information comprising the prioritization indicates that neither the ANR measurement nor the cell reselection should be performed.

Example Embodiment 13. The method of any one of Embodiments 1 to 8, wherein the second cell is not the same as the target cell.

Example Embodiment 14. The method of Embodiment 13, wherein the information comprising the prioritization indicates that the cell reselection should be performed before the ANR measurement is performed.

Example Embodiment 15. The method of Embodiment 13, wherein the information comprising the prioritization indicates that the ANR measurement should be performed before the cell reselection is performed.

Example Embodiment 16. A method performed by a base station, the method comprising: transmitting, to a UE, information comprising a prioritization of one of an ANR measurement and a cell change over the other one of the ANR measurement and the cell change.

Example Embodiment 17. The method of Embodiment 16, wherein the UE is an RRC state in which the UE autonomously switches from a source cell to a target cell.

Example Embodiment 18. The method of Embodiment 17, wherein the RRC state comprises an RRC connected state, an RRC idle state, an RRC idle state, or an RRC inactive state.

Example Embodiment 19. The method of any one of Embodiments 16 to 18, wherein the second cell is the same as the target cell.

Example Embodiment 20. The method of Embodiment 19, wherein the information comprising the prioritization indicates that the ANR measurement should not be performed and the cell reselection should be performed.

Example Embodiment 21. The method of Embodiment 19, wherein the information comprising the prioritization indicates that the ANR measurement should be performed and the cell reselection should be not be performed.

Example Embodiment 22. The method Embodiment 19, wherein the information comprising the prioritization indicates that neither the ANR measurement nor the cell reselection should be performed.

Example Embodiment 23. The method of any one of Embodiments 16 to 18, wherein the second cell is not the same as the target cell.

Example Embodiment 24. The method of Embodiment 23, wherein the information comprising the prioritization indicates that the cell reselection should be performed before the ANR measurement is performed.

Example Embodiment 25. The method of Embodiment 23, wherein the information comprising the prioritization indicates that the ANR measurement should be performed before the cell reselection is performed.

Example Embodiment 26. A wireless device for improving network efficiency, the wireless device comprising: processing circuitry configured to perform any of the steps of any of Claims 1 to 15; and power supply circuitry configured to supply power to the wireless device.

Example Embodiment 27. A base station for improving network efficiency, the base station comprising: processing circuitry configured to perform any of the steps of any of the Group B embodiments; power supply circuitry configured to supply power to the wireless device.

Example Embodiment 28. A user equipment (UE) for improving network efficiency, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Claims 1 to 15; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 29. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

Example Embodiment 30. The communication system of the pervious embodiment further including the base station.

Example Embodiment 31. The communication system of the previous 2 embodiments, further including the UE, wherein the UE is configured to communicate with the base station.

Example Embodiment 32. The communication system of the previous 3 embodiments, wherein: the processing circuitry of the host computer is configured to execute a host application, thereby providing the user data; and the UE comprises processing circuitry configured to execute a client application associated with the host application.

Example Embodiment 33. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group B embodiments.

Example Embodiment 34. The method of the previous embodiment, further comprising, at the base station, transmitting the user data.

Example Embodiment 35. The method of the previous 2 embodiments, wherein the user data is provided at the host computer by executing a host application, the method further comprising, at the UE, executing a client application associated with the host application.

Example Embodiment 36. A user equipment (UE) configured to communicate with a base station, the UE comprising a radio interface and processing circuitry configured to performs the of the previous 3 embodiments.

Example Embodiment 37. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of Claims 1 to 15.

Example Embodiment 38. The communication system of the previous embodiment, wherein the cellular network further includes a base station configured to communicate with the UE.

Example Embodiment 39. The communication system of the previous 2 embodiments, wherein: the processing circuitry of the host computer is configured to execute a host application, thereby providing the user data; and the UE's processing circuitry is configured to execute a client application associated with the host application.

Example Embodiment 40. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of Claims 1 to 15.

Example Embodiment 41. The method of the previous embodiment, further comprising at the UE, receiving the user data from the base station.

Example Embodiment 42. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of Claims 1 to 15.

Example Embodiment 43. The communication system of the previous embodiment, further including the UE.

Example Embodiment 44. The communication system of the previous 2 embodiments, further including the base station, wherein the base station comprises a radio interface configured to communicate with the UE and a communication interface configured to forward to the host computer the user data carried by a transmission from the UE to the base station.

Example Embodiment 45. The communication system of the previous 3 embodiments, wherein: the processing circuitry of the host computer is configured to execute a host application; and the UE's processing circuitry is configured to execute a client application associated with the host application, thereby providing the user data.

Example Embodiment 46. The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Example Embodiment 47. A method implemented in a communication system including a host computer, a base station and a user equipment (UE), the method comprising: at the host computer, receiving user data transmitted to the base station from the UE, wherein the UE performs any of the steps of any of Claims 1 to 15.

Example Embodiment 48. The method of the previous embodiment, further comprising, at the UE, providing the user data to the base station.

Example Embodiment 49. The method of the previous 2 embodiments, further comprising: at the UE, executing a client application, thereby providing the user data to be transmitted; and at the host computer, executing a host application associated with the client application.

Example Embodiment 50. The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

Example Embodiment 51. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

Example Embodiment 52. The communication system of the previous embodiment further including the base station.

Example Embodiment 53. The communication system of the previous 2 embodiments, further including the UE, wherein the UE is configured to communicate with the base station.

Example Embodiment 54. The communication system of the previous 3 embodiments, wherein: the processing circuitry of the host computer is configured to execute a host application; the UE is configured to execute a client application associated with the host application, thereby providing the user data to be received by the host computer.

Example Embodiment 55. A method implemented in a communication system including a host computer, a base station and a user equipment (UE), the method comprising: at the host computer, receiving, from the base station, user data originating from a transmission which the base station has received from the UE, wherein the UE performs any of the steps of any of Claims 1 to 15.

Example Embodiment 56. The method of the previous embodiment, further comprising at the base station, receiving the user data from the UE.

Example Embodiment The method of the previous 2 embodiments, further comprising at the base station, initiating a transmission of the received user data to the host computer.

### Additional Information

At RAN #82, updated Rel-16 work item on Rel-16 enhancements for NB-eoT was approved. See, RP-182902, “Additional enhancements for NB-IoT”, Huawei, RAN #82, 10-13 Dec. 2018. One of the objectives in this work item is to support SON reporting for random access performance and radio link failure for network management.

Network management tool enhancement:
SON support for reporting of [RAN2, RAN3]
Cell Global Identity and strongest measured cell(s) (ANR)
Random access performance
Radio link failure (RLF), if needed

Below are the agreements from RAN2 meetings on ANR. RAN2#103bis agreements:

| | |
|---|---|
| • | ANR reporting for NB-IoT only uses idle-mode measurements (i.e. we won't |
| | introduce connected mode measurements) |

RAN2#104 agreements:
SON-ANR:

| | |
|---|---|
| • | RAN2 understanding is that the purpose of SON/ANR reporting in NB-IoT is |
| | network optimisation rather than immediately updating neighbour relations like with |
| | LTE ANR, and is therefore not time critical. |
| • | SON reporting does not trigger RRC connection establishment/resume |
| • | For further study whether this includes EDT. |
| • | SON information can be reported along with EDT, FFS what and how. |

RAN2#105 agreements:

| Solution direction based on option a (Immediate measurements): | |
|---|---|
| ▪ | Single set of measurements only. |
| ▪ | No new measurement requirements. |
| ▪ | ANR measurement reporting using the UE Information Request/ |
| | Response framework is supported. Other methods FFS. |
| ▪ | ANR reporting for the CP solution is not supported in Rel-16. |

In LTE, ANR is performed during connected mode, that is UE detects PCI of a strong cell and reports it via Measurement Report. Thereafter, NW can configure autonomous gap for the UE to use the gap to identify the CGI of the cell (reading MIB and SIB1).

Identifying the CGI implies, UE needs to read the MIB and SIB information of the detected strong cell which could be battery consuming. NW should ensure that UE is not bound to perform the CGI reporting frequently.

Here the definition of a strong cell could for example be that the measured RSRP or RSRQ values from a certain cell exceeds a certain threshold value, where for example, the threshold is the RSRP/RSRQ threshold parameters used for cell reselection. The threshold could be absolute levels but also a difference between the serving/camped cell and the strong cell.

In NB-IoT, in order to save battery, it is recommended that the UE performs logged measurement during idle mode, thus there may not be any interaction with the NW for CGI discovery. The UE may have to autonomously decide to obtain that or based upon white or black list of PCI that is configured by the Network. Further, it has been agreed to use a single set of measurements. Below, how a single set of measurement would be is illustrated.

After the UE is released from connected mode and has been configured for ANR measurements, the UE using its normal DRX cycle (10.24 sec) would perform cell reselection related measurements for 2 samples. If it detects any cell that meets strong cell criteria after averaging the results over 2 samples; then UE would perform a CGI discovery during the third interval of cell reselection and exit from the ANR measurement.

FIG. 2, discussed above, depicts a UE performing CGI detection at the 3^{rd} interval. If the UE happens to detect the same strong cell as a cell reselection candidate for at least two samples or based upon averaging result of two samples, then the UE performs the identification of the CGI and stores/logs the value. This would ensure that the results are credible, and it also allows UE to exit the ANR results early (after this single set of measurement).

Each of the below mechanisms has their use in ANR measurement, and therefore propose to use a flexible mechanism, which combines the three solutions discussed above.

### Immediate Measurement:

Having immediate measurements would imply UE would defer going to deep sleep or avoid relaxed monitoring measurements.

### Cell Reselection:

Cell reselection intervals can be used to perform ANR measurements (using cell reselection interval defined by normal drxCycle).

### Strong Cell:

ANR measurement would be based upon strong cell detection such that threshold below certain RSRP would not be required to be recorded.

ANR would most likely be one time activity and only portion of UEs would be selected to perform ANR measurements, the overhead of ANR would be insignificant. Thus, a single set of measurement combining two cell reselection results and a third sample for CGI discovery would not be considerable overhead. Further, it should be noted that it would be difficult for the UE to perform the measurement and also perform the CGI discovery in one on duration timer, the UE would need more than one on duration timer to perform the measurements.

It has been observed that overhead of ANR would be insignificant as it would be triggered seldomly and only portion of UEs would be selected to perform the measurements.

It is proposed that ANR measurement are defined as two averaged samples of cell reselection and if this result suggest a strong cell discovery then a third measurement interval is used for CGI discovery.

According to another embodiment, the UE based on rule may perform different measurements (e.g. positioning and ANR) over at least partially overlapping time or prioritize one over the other. The rule may be preconfigured or configured by the network node, which may include a base station, location server, etc. The rule may consider positioning specific configurations parameters into account such as Positioning NPRS periodicity (Tnprs) and/or number of NPRS subframes within a positioning occasion [3GPP TS 36.355 v15.6.0].

nprs-Period

This field specifies the NPRS occasion period T_{NPRS} (TS 36.211 [16]). Enumerated values correspond to 160 ms, 320 ms, 640 ms, 1280 ms, and 2560 ms. The value ms2560 is only applicable to TDD mode.

nprs-NumSF

This field specifies the number of consecutive downlink subframes N_{NPR}S in one NPRS positioning occasion (TS 36.211 [16]). Enumerated values correspond to 10, 20, 40, 80, 160, 320, 640, 1280, and 2560 subframes. The values sf10 and sf20 are only applicable to FDD mode. The value sf2560 is only applicable to TDD mode.

According to one example of a general rule, the UE may meet the existing positioning measurement requirements even if the positioning measurements and ANR measurements are performed over partially overlapping time period. The rule may particularly be applicable for certain type of positioning measurements such as, for example, RSTD. Non-limiting examples of positioning measurement requirements comprises positioning measurement period, positioning measurement accuracy, positioning measurement reporting delay, number of positioning measurements that can be performed by the UE over the positioning measurement period, etc. The term existing positioning requirements used herein corresponds to the requirements to be met by the UE for performing the positioning measurement within a measurement time over which the UE is not configured to perform any ANR measurement. The term existing positioning measurement requirements may interchangeably be called as legacy positioning measurement requirements. For example the UE shall meet the existing positioning requirements even if:
the positioning measurement/session starts while the ANR measurement is ongoing and/or
the ANR measurement starts while the positioning measurement/session is ongoing.

In general, in one example in order to comply to the above rule, the UE will have to adapt the ongoing ANR measurement procedure. In another example in order to comply to the above rule, the UE will have to adapt the start of ANR measurement procedure. The adaptation can therefore be performed by the UE to the ongoing or newly started ANR measurement procedure. The adaptation may ensure that the UE is able to meet the existing positioning measurement requirements. Examples of adaptation of the ANR measurement procedure comprising one or more of:
suspending the ongoing or new started ANR procedure for certain duration (T1),
delaying or deferring or postponing the start of the ANR procedure up to certain time period (T2),
extending the duration of the ongoing or new started ANR procedure by certain duration (T3),
discarding the ongoing ANR measurements,
discarding or stopping the newly started ANR measurements.
   The rule is elaborated with specific example below for intra-frequency RSTD measurement.

When the physical layer cell identities of the neighbour cells together with the OTDOA assistance data have been provided and the UE has entered the RRC_IDLE state, the UE shall be able to detect and measure intra-frequency RSTD for at least n=16 cells, including the reference cell, on the same carrier frequency f1 as that of the reference cell within T_{RSTD IntraFreq, NB} ms as given below:

T_{RSTD IntraFreq,NB}=T_{NPRS}·(M−1)+Δms,

where

T_{RSTD IntraFreq, NB} is the total time for detecting and measuring at least n cells;

T_{NPRS} is the cell-specific positioning subframe configuration period as defined in TS 36.355 [24] if Part B subframe configuration is provided; otherwise if only Part A subframe configuration is provided, the T_{NPRS} equals to the length of the subframe pattern,

M is the number of NPRS positioning occasions as defined in Table 4.8.1-1,

$$Δ = {T}_{N P R S} \cdot ⌈ \frac{n}{M} ⌉$$

ms is the measurement time for a single NPRS positioning occasion which includes the sampling time and the processing time;

N_{NPRS} is the cell-specific number of NPRS subframes within a NPRS occasion as defined in TS36.355[24] if Part B subframe configuration is provided; if only Part A subframe configuration is provided, the NPRS occasion length is 10 ms,

N_{NPRS_total} is the minimum number of NPRS subframes per cell measurement as specified in Section 9.1.22.10.

T_{NPRS}, N_{NPRS}, and, N_{NPRS_total} are the parameters of the same cell, for which

$${T}_{N P R S} \cdot ⌈ \frac{{N}_{NPRS\_total}}{{N}_{N P R S}} ⌉$$

is the largest among all the measured cells.

According to the rule the UE shall perform the RSTD measurement over T_{RSTD IntraFreq, NB} ms even if the UE is configured to perform the ANR measurement while the UE is performing the RSTD measurement or if the UE is configured to perform the RSTD measurement while the UE is performing the ANR measurement. The adaptation may further depend upon one or more parameters associated with the measurement configuration e.g. NPRS periodicity (T_{NPRS}), NPRS positioning occasion duration (e.g. number of NPRS subframes etc). This is elaborated with few examples:
In one example: If T_{NPRS}≤threshold1 (H1) then the UE stops or discards the ANR measurement.
In another example: If H1<T_{NPRS}≤threshold2 (H2) then the UE continues doing the ANR measurement but extend the ANR measurement period,
In yet another example: If T_{NPRS}>H2 then the UE may also continue doing the ANR measurement without impacting ANR measurement performance.
   According to another aspect of this embodiment the priority rule depends on type of positioning measurement. For example:
the UE shall meet the existing positioning measurement requirements for a type 1 positioning measurements even if the positioning measurement/session starts while the ANR measurements is ongoing,
the UE is allowed to relax the positioning measurement requirements for a type 2 positioning measurements if the positioning measurement/session starts while the ANR measurements is ongoing and/or if the ANR measurements positioning measurement/session starts while the positioning measurement/session is ongoing.

Type 1 positioning measurement is of higher priority compared to type 2 positioning measurements. For example type 1 positioning measurements is related to critical services (e.g. emergency call) while type 2 positioning measurements is related to non-critical services (e.g. commercial service). A specific example of Type 1 positioning measurement is RSTD and specific examples of Type 2 positioning measurements are E-CID positioning measurement (e.g. NRSRP, NRSRQ, UE Rx-Tx time difference etc).

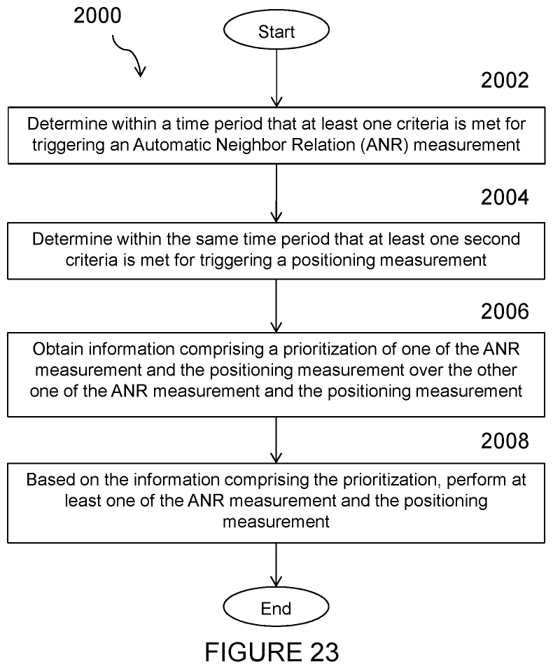

FIG. 23 depicts another method 2000 performed by a wireless device 310, according to certain embodiments. In a particular embodiment, the wireless device 310 is a UE. At step 2002, the wireless device determines within a time period that at least one criteria is met for triggering an ANR measurement. At step 2004, the wireless device 310 determines within the same time period that at least one second criteria is met for triggering a positioning measurement. At step 2006, the wireless device 310 obtains information comprising a prioritization of one of the ANR measurement and the positioning measurement over the other one of the ANR measurement and the positioning measurement. Based on the information comprising the prioritization, the wireless device 310 performs at least one of the ANR measurement and the positioning measurement, at step 2008.

In a particular embodiment, the positioning measurement comprises a Reference Signal Time Difference (RSTD) measurement.

In a particular embodiment, when performing the at least one of the ANR measurement and the positioning measurement, the wireless device 310 meets at least one positioning measurement requirement. In a further particular embodiment, the at least one positioning measurement requirement includes at least one of: a positioning measurement period, a positioning measurement accuracy, a positioning measurement reporting delay, and a number of positioning measurements to be performed by the UE over a positioning measurement period.

In a particular embodiment, performing the at least one of the ANR measurement and the positioning measurement comprises: starting the ANR measurement; and starting the positioning measurement while the ANR measurement is ongoing. In a further particular embodiment, the wireless device 310 adapts a ANR measurement procedure by performing at least one of: suspending the ANR measurement for a first time period; extending a duration of the ANR procedure for a second time period; and discarding the ongoing ANR measurement.

In a particular embodiment, performing the at least one of the ANR measurement and the positioning measurement comprises: starting the positioning measurement; and starting the ANR measurement while the positioning measurement is ongoing. In a further particular embodiment, the wireless device 310 adapts a ANR measurement procedure by performing at least one of: suspending the ANR measurement for a first time period; delaying or deferring a start of the ANR procedure for a second time period; extending a duration of the ANR procedure for a third time period; and discarding or stopping the ANR measurement.

In a particular embodiment, when performing the at least one of the ANR measurement and the positioning measurement based on the information comprising the prioritization, the wireless device 310 performs one of:
if a Narrowband Positioning Reference Signal, NPRS, periodicity associated with the positioning measurement is greater than or equal to a first threshold, stopping or discarding the ANR measurement;
if a NPRS periodicity associated with the positioning measurement is greater than a third threshold but less than or equal to a fourth threshold, continuing the ANR measurement and extending an ANR measurement period; or
if a NPRS periodicity is greater than a fifth threshold, continuing the ANR measurement without modification.

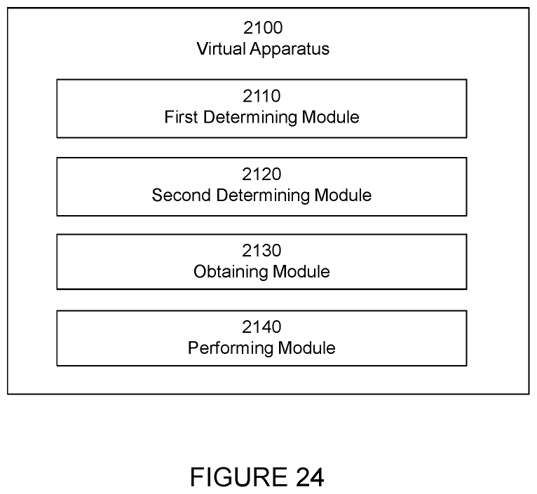

FIG. 24 illustrates a schematic block diagram of another virtual apparatus 2100 in a wireless network (for example, the wireless network shown in FIG. 4). The apparatus may be implemented in a wireless device or network node (e.g., wireless device 310 or network node 360 shown in FIG. 4). Apparatus 2100 is operable to carry out the example method described with reference to FIG. 23 and possibly any other processes or methods disclosed herein. It is also to be understood that the method of FIG. 23 is not necessarily carried out solely by apparatus 2100. At least some operations of the method can be performed by one or more other entities.

Virtual Apparatus 2100 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first determining module 2110, second determining module 2120, obtaining module 2130, performing module 2140, and any other suitable units of apparatus 2100 to perform corresponding functions according one or more embodiments of the present disclosure.

According to certain embodiments, first determining module 2110 may perform certain of the determining functions of the apparatus 2100. For example, first determining module 2110 may determine within a time period that at least one criteria is met for triggering an ANR measurement.

According to certain embodiments, second determining module 2120 may perform certain other of the determining functions of the apparatus 2100. For example, second determining module 2120 may determine within the same time period that at least one second criteria is met for triggering a positioning measurement.

According to certain embodiments, obtaining module 2130 may perform certain of the obtaining functions of the apparatus 2100. For example, obtaining module 2130 may obtain information comprising a prioritization of one of the ANR measurement and the positioning measurement over the other one of the ANR measurement and the positioning measurement.

According to certain embodiments, performing module 2140 may perform certain of the performing functions of the apparatus 2100. For example, based on the information comprising the prioritization, performing module 2140 may perform at least one of the ANR measurement and the positioning measurement.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

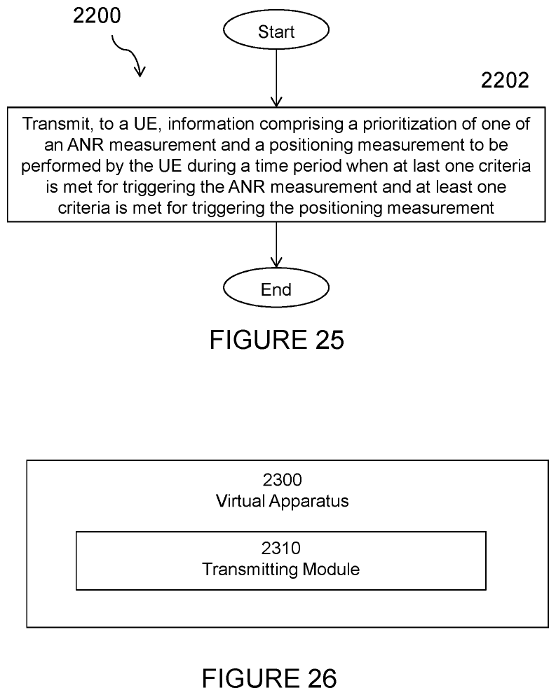

FIG. 25 depicts another method 2200 performed by a network node 360, according to certain embodiments. At step 2202, the network node 360 may transmit, to wireless device 310 such as a UE 400, information comprising a prioritization of one of an ANR measurement and a positioning measurement to be performed by the wireless device 310 during a time period when at least one criteria is met for triggering the ANR measurement and at least one criteria is met for triggering the positioning measurement.

In a particular embodiment, the positioning measurement comprises a RSTD measurement.

In a particular embodiment, the information indicates that, when performing the at least one of the ANR measurement and the positioning measurement, the wireless device 360 is to meet at least one positioning measurement requirement. In a further particular embodiment, the at least one positioning measurement requirement includes at least one of: a positioning measurement period, a positioning measurement accuracy, a positioning measurement reporting delay, and a number of positioning measurements to be performed by the UE over a positioning measurement period.

In a particular embodiment, network node 360 configures the wireless device 310 to start the positioning measurement while the ANR measurement is ongoing. In a further particular embodiment, the network node 360 configures the wireless device 310 to adapt an ANR measurement procedure by performing at least one of: suspending the ANR measurement for a first time period; extending a duration of the ANR procedure for a second time period; and discarding the ongoing ANR measurement.

In a particular embodiment, network node 360 configures the wireless device 310 to start the ANR measurement while the positioning measurement is ongoing. In a further particular embodiment, the network node 360 configures the wireless device 310 to adapt an ANR measurement procedure by performing at least one of: suspending the ANR measurement for a first time period; delaying or deferring a start of the ANR procedure for a second time period; extending a duration of the ANR procedure for a third time period; and discarding or stopping the ANR measurement.

In a particular embodiment, the network node 360 configures the wireless device 310 to perform one of:
if a NPRS periodicity associated with the positioning measurement is greater than or equal to a first threshold, stop or discard the ANR measurement;
if a NPRS periodicity associated with the positioning measurement is greater than a third threshold but less than or equal to a fourth threshold, continue the ANR measurement and extending an ANR measurement period; or
if a NPRS periodicity is greater than a fifth threshold, continue the ANR measurement without modification.

FIG. 26 illustrates a schematic block diagram of another virtual apparatus 2300 in a wireless network (for example, the wireless network shown in FIG. 4). The apparatus may be implemented in a wireless device or network node (e.g., wireless device 310 or network node 360 shown in FIG. 4). Apparatus 2300 is operable to carry out the example method described with reference to FIG. 25 and possibly any other processes or methods disclosed herein. It is also to be understood that the method of FIG. 25 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 2310 and any other suitable units of apparatus 2300 to perform corresponding functions according one or more embodiments of the present disclosure.

According to certain embodiments, transmitting module 2310 may perform certain of the transmitting functions of the apparatus 2300. For example, transmitting module 2310 may transmit, to wireless device 310 such as a UE 400, information comprising a prioritization of one of an ANR measurement and a positioning measurement to be performed by the wireless device 310 during a time period when at least one criteria is met for triggering the ANR measurement and at least one criteria is met for triggering the positioning measurement.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a user equipment, UE, served in a first cell, the method comprising:
determining within a time period that at least one criteria is met for triggering acquiring a Cell Global Identity, CGI, in a second cell;
determining within the time period that at least one second criteria is met for triggering a cell change from a source cell to a target cell;
obtaining information comprising a prioritization of one of acquiring the CGI and the cell change over the other one of the acquiring the CGI and the cell change; and
based on the information comprising the prioritization, performing one of the acquiring the CGI in the second cell or the cell change from the source cell to the target cell.

2.-9. (canceled)

10. A method performed by a network node, the method comprising:
transmitting, to a user equipment, UE, information comprising a prioritization of one of acquiring a Cell Global Identity, CGI, and a cell change over the other one of the acquiring the CGI and the cell change.

11.-18. (canceled)

19. A User Equipment, UE, served in a first cell comprises:
processing circuitry configured to:
determine within a time period that at least one criteria is met for triggering acquiring a Global Cell Identity, CGI, in a second cell;
determine within the time period that at least one second criteria is met for triggering a cell change from a source cell to a target cell;
obtain information comprising a prioritization of one of the acquiring the CGI and the cell change over the other one of the acquiring the CGI and the cell change; and
based on the information comprising the prioritization, perform one of acquiring the CGI in the second cell or the cell change from the source cell to the target cell.

20. The wireless device of claim 19, wherein the at least one criteria for triggering acquiring the CGI comprises a detection of a strong cell.

21. The wireless device of claim 19, wherein the UE is in an Radio Resource Control, RRC, state in which the UE autonomously switches from a source cell to a target cell, and wherein the RRC state comprises an RRC idle state or an RRC inactive state.

22. The wireless device of claim 19, wherein the at least one criteria triggering acquiring the CGI comprises a comparison of a Physical Cell Identity, PCI, of the second cell with information received from a network node.

23. The wireless device of claim 22, wherein the at least one criteria triggering acquiring the CGI comprises the PCI of the second cell being part of a white list that a network node is interested in or the PCI of the second cell not belonging to a black list that the network node is not interested.

24. The wireless device of claim 19, wherein when obtaining the information comprising the prioritization, the processing circuitry is configured to receive a signal from a network node indicating that the UE is to prioritize acquiring the CGI or the cell change.

25. The wireless device of claim 19, wherein the second cell is the same as the target cell, and wherein the information comprising the prioritization indicates that:
acquiring the CGI should not be performed and the cell reselection should be performed;
acquiring the CGI should be performed and the cell reselection should be not be performed; or
neither acquiring the CGI nor the cell reselection should be performed.

26. The wireless device of claim 19, wherein the second cell is not the same as the target cell, and wherein the information comprising the prioritization indicates that:
the cell reselection should be performed before acquiring the CGI; or
acquiring the CGI should be performed before the cell reselection is performed.

27. The wireless device of claim 19, wherein the at least one criteria triggering acquiring the CGI comprises at least one criteria triggering an Evolved Cell Global Identity, eCGI, reading.

28. A network node comprising:
processing circuitry configured to:
transmit, to a user equipment, UE, information comprising a prioritization of one of acquiring a Cell Global Identity, CGI, and a cell change over the other one of the acquiring the CGI and the cell change.

29. The network node of claim 28, wherein the UE is a Radio Resource Control, RRC, state in which the UE autonomously switches from a source cell to a target cell, and wherein the RRC state comprises an RRC idle state or an RRC inactive state.

30. The network node of claim 28, wherein acquiring the CGI is for a second cell, and wherein the cell change is from a source cell to a target cell.

31. The network node of claim 30, wherein the second cell is the same as the target cell, and wherein the information comprising the prioritization indicates that:
acquiring the CGI should not be performed and the cell reselection should be performed;
acquiring the CGI should be performed and the cell reselection should not be performed; or
neither acquiring the CGI nor the cell reselection should be performed.

32. The network node of claim 30, wherein the second cell is not the same as the target cell, and wherein the information comprising the prioritization indicates that:
the cell reselection should be performed before acquiring the CGI; or
acquiring the CGI should be performed before the cell reselection is performed.

33. The network node of claim 28, wherein the processing circuitry is configured to configure the UE with at least one criteria for triggering acquiring the CGI, the at least one criteria comprising a detection of a strong cell by the UE.

34. The network node of claim 28, wherein the processing circuitry is configured to configure the UE with at least one criteria for triggering the acquiring the CGI, the at least one criteria comprising a comparison of a Physical Cell Identity, PCI, of the second cell with PCI information received from the network node.

35. The network node of claim 34, wherein the processing circuitry is configured to transmit the PCI information to the UE, the PCI information comprising:
a white list of at least one PCI of which the network node is interested; or
a black list of at least one PCI of which the network node is not interested.

36. The network node of claim 28, wherein acquiring the CGI comprises performing an Evolved Cell Global Identity, eCGI, reading.

37.-54. (canceled)

55. A User Equipment, UE, comprises:
processing circuitry configured to:
determine within a time period that at least one criteria is met for triggering an Automatic Neighbor Relation, ANR, measurement;
determine within the same time period that at least one second criteria is met for triggering a positioning measurement;
obtain information comprising a prioritization of one of the ANR measurement and the positioning measurement over the other one of the ANR measurement and the positioning measurement; and
based on the information comprising the prioritization, perform at least one of the ANR measurement and the positioning measurement.

56.-72. (canceled)
